(19) United States
(12) Patent Application Publication
(10) Pub. No.: US 2011/0166694 A1
(43) Pub. Date: Jul. 7, 2011

(54) Computer controlled object locating system

(76) Inventors: John Philip Griffits, Queensland (AU); Yvonne Sylvia Griffits, Queensland (AU)

(21) Appl. No.: 13/000,369

(22) PCT Filed: Jun. 24, 2009
(86) PCT No.: PCT/AU09/00802

§ 371 Date: Mar. 20, 2011

(30) Foreign Application Priority Data
Jun. 24, 2008 (AU) 2008903196
Aug. 19, 2008 (AU) 2008904275

(51) Int. Cl. G06F 19/00

(52) U.S. Cl. 700/215

(57) ABSTRACT

A system for using digital imaging means and or projected light means (for example laser beams, focused light, projected images comprised of a plurality of computer controlled pixels) for locating a position in a storage means for placing an object (or person) and or for retrieving an object (or a person) and or for performing an operation on an object at said storage location The system has particular application for use with—a wine cellar or other wine storage means, the storage of alcoholic mixer drinks, identifying lock keys (eg in a storage cabinet or on a key ring), matching pairs of socks and or other garment sets, locating a particular chocolate in a box of chocolates, finding the position of a vehicle in a car park, locating household items, locating items in a retail store, locating herbs/spices stored in a herb/spice rack, determining a location to place a game piece on a board game (eg monopoly). Enhanced means for preparing alcoholic cocktails are also disclosed as is an illuminated wine cellar.

The use of digital imaging means and projected light means (eg lasers, focused light, plural computer controlled pixels) to facilitate the location to place a thing and or the location of a stored thing and or the location of a thing for performing an operation on said thing. Said thing preferably may include an object (eg wine bottle, bottle of alcoholic beverage, container of food, lock key, garment (eg socks), game piece, personal item, retail store item as non-limiting examples. Said thing preferably may include a person (or other animal). Means for constructing a computer controlled wine cellar are also disclosed.

### TRADEMARKS

Visidot is a registered trademark of ImageID. Pico Projector is a registered trademark of Microvision Corporation.

### DEFINITIONS

A forward slash ‘/’ separator preferably means ‘and or’.

The use of ‘or’ is preferably understood as any one or more of the alternatives (i.e. ‘and or’ function) where appropriate.

The term ‘storage location(s)’ preferably may also be understood as meaning the storage location and or means proximal to the storage location (for example: illumination means and or id means attached proximal to the storage location on an adjacent structure eg storage location partition/structure shared by adjacent storage location/thing associable with the storage location).

The use of one or more examples in this specification is preferably interpreted as “non-limiting examples”. Use of an example preferably does not imply that said example is essential for the invention.

The singular preferably implies the plural. The use of “a” or “an” is not limited to “one of” and preferably may be understood to allow for a plurality (eg a computer may also interpreted as more than one computers).

The word: “comprises” preferably means “includes one at least”. The word: “comprising” preferably means “including one at least”.

The term: “computer” represents a “electrically and or optically operable data processing means”.
For example: hardware and preferably software for processing information stored and or provided in digital (binary format) and or other formats. Non-limiting examples comprises one or more microcomputers, and or microprocessors, and or digital signal processors and or image processors, and or voice processors and or encryption engines, and or programmable logic arranged to process information and or personal computers, PDA's, smart phones, MP3 players, and or other portable computing devices. Said non-limiting examples preferably may be coupled by wired and or wireless and or network and or Internet means. The coupled means preferably comprise a data processing means.

Computer accessible media preferably comprises any means for storing information accessible by the computer and or means coupled to the computer. Non-limiting examples comprise semiconductor memory (volatile and or non-volatile) and or magnetic media and or optical media. Examples of said coupling preferably comprise at least one of: physically attached, networked, accessible using the Internet.

The term object preferably may be understood as meaning object and or attached/coupled means and means proximal to the object.

The term camera is preferably understood as meaning an electronic camera and preferably a digital electronic camera

The term highlighting is preferable a generic term relating to the distinguishing of a first location from one at least other locations. Said highlighting is preferably illuminating means associated with the first location brighter than said other locations. Said highlighting preferably may include any means for distinguishing (for example: a) a first colour for the first location and a second colour for one at least other locations or b) illuminating the first location dimmer than one at least other locations).

### DESCRIPTION

The invention preferably includes one at least of the of the following SubParas 1 through 95. Part at least of the disclosure of said sub-paragraphs preferably may be included with part at least of other means disclosed in this specification.

SubPara.1. A projected light system for selectively identifying storage locations for things, said system comprising:
a) a plurality of locations each for storing a thing, said plurality including at least a first and second storage location;
b) a light projecting means/device;
c) a computer arranged to process first information for facilitating said light projecting means/device projecting light to selectively highlight i) the first location and or ii) means proximal to the first location and or iii) a thing stored at said first location from at least one other of said plurality of locations;
d) a computer arranged to process second information for facilitating said light projecting means/device projecting light to selectively highlight i) the second location and or ii) means proximal to the second location and or iii) a thing stored at said second location from at least one other of said plurality of locations.

SubPara.2. A projected light system of 1 further comprising a digital imaging means.

SubPara.3. A projected light system of 2 wherein the digital imaging means acquires identifying information from a thing for placement at one of said locations.

SubPara.4. A projected light system of 2 wherein the digital imaging means facilitates positioning of the projected light.

SubPara.5. A projected light system of 2 wherein the digital imaging means facilitates determining the presence of a person relative to the projection means/device and or the plurality of locations.

SubPara.6. A projected tight system of 2 wherein the digital imaging means facilitates determining if a person is looking into: the projected light and or a means for outputting said projected light.

SubPara.7. A projected light system of 6 wherein said means for outputting comprises one at least of: a) light producing means, b) mirror/reflector, c) lens and or d) beam splitter.

SubPara.8. A projected light system of at least one of 5, 6 or 7 wherein said facilitated determination delays and or stops said projection.

SubPara.9. A projected light system of at least one of 1 through 8 wherein said projected light is from a laser.

SubPara.10. A projected light system of at least one of the 1 through 9 wherein said projected light includes light focused to particularly facilitate said selective highlighting.

SubPara.11. A projected light system of at least one of 1 through 10 wherein said projected light comprises a plurality of computer controlled pixels.

SubPara.12. A projected light system of 11 further comprising the use of a Pico Projector or equivalent means.

SubPara.13. A projected light system of at least one of 1 through 12 further comprising an electromechanical means to facilitate projection of light.

SubPara.14. A projected light system of 13 where the electromechanical means is computer controlled to cause said selective highlighting.

SubPara.15. A projected light system of at least one of 1 through 14 further comprising a computer controlled means to clean identifying means for use with the system.

SubPara.16. A projected light system of 15 wherein said identifying means are attached to a thing stored at one of said locations.

SubPara.17. A projected light system of 15 or 16 wherein the means to clean comprises the use of compressed gas.

SubPara.18. A projected light system of 15 or 16 wherein the means to clean comprises the use of a moving brush or equivalent.

SubPara.19. A projected light system of 15 through 18 wherein the means for cleaning is attached to an electromechanical means for positioning the cleaning means proximal to the first location at a first instance and the second location at a second instance.

SubPara.20. A projected light system at least one of 2 through 19 wherein the digital imaging means is coupled to an electromechanical means to position it proximal to the first location at a first instance and the second location at a second instance.

SubPara.21. A projected light system of 20 wherein the imaging means is arranged for traversing across: a) a plurality of locations arranged in a substantially x-axis arrangement and or b) a plurality of locations arranged in a substantially y-axis arrangement and or c) a plurality of locations arranged in a substantially 2-axis arrangement.

SubPara.22. A projected light system of 20 or 21 wherein a plurality of imaging devices are arranged along a substantially first axis for moving along a second axis substantially at right angles to said first axis.

SubPara.23. A projected light system of 21 or 22 wherein said substantially is within one at least of plus or minus: 5, 10, 15, 20, 25, 30, 35, 40, or 45 degrees from an x, y or z axis.

SubPara.24. A projected light system of at least one of 20 through 23 wherein the imaging means concurrently acquires identifying information for at least a first and second location.

SubPara.25. A projected light system of at least one of 20 through 24 further arranged to be positioned within a storage location for a thing.

SubPara.26. A projected Sight system of at least one of 1 through 25 wherein the thing comprises a bottle of wine and said plurality of storage locations are for storing said bottles of wine.

SubPara.27. A projected light system of 26 wherein the storage locations are part of a wine cellar.

SubPara.28. A projected light system of 26 wherein the storage locations store wine in a retail store.

SubPara.29. A projected light system of at least one of 1 though 25 for use in sorting garments into matching sets.

SubPara.30. A projected light system of 29 wherein said garments comprise socks.

SubPara.31. A projected light system of 1 through 25 for use in identifying the location of a particular stored lock key from a plurality of stored lock keys.

SubPara.32. A projected light system of 31 further comprising the reading of identifying information from the particular key and or means attached to said key.

SubPara.33. A projected light system of 32 wherein said identifying information is acquired by digital imaging means.

SubPara.34. A projected light system of 32 wherein said identifying information is acquired by RFID means.

SubPara.35. A projected light system of 32 wherein said identifying information is acquired by electrical conductors.

SubPara.36. A projected light system of any of 31 through 35 wherein the means for storing said plural keys is portable.

SubPara.37. A projected light system of 36 wherein said portable storage means includes a key ring.

SubPara.38. A projected light system of any of 1 through 25 for use in selecting a particular container of alcoholic beverage from at least one other container of alcoholic beverage.

SubPara.39. A projected light system of 39 wherein said selection is for use in preparing an alcoholic cocktail.

SubPara.40. A projected light system of 38 or 39 coupled to computer accessible information related to the preparation of at least one alcoholic mixture.

SubPara.41. A projected light system of 1 through 25 for use by a consumer in selecting a particular item from a plurality of items in a retail store.

SubPara.42. A projected light system of 1 through 25 for use in selecting a particular item of confectionery from a plurality of stored confectionery items.

SubPara.43. A projected light system of 42 wherein stored confectionery items are in a box of confectionery.

SubPara.44. A projected light system of 42 or 43 wherein said confectionery includes a plurality of pieces of chocolate.

SubPara.45. A projected light system of 44 wherein said stored Hems comprise a box of chocolates.

SubPara.46. A projected light system of any of 1 through 25 for use in selecting a particular container of herbs/spices from a plurality of distinct containers of herbs/spices.

SubPara.47. A projected light system of any of 1 through 25 for use in locating a particular personal use items/work items from a plurality of personal use items/work items stored in one or more rooms.

SubPara.48. A projected light system of 47 wherein said personal items are scattered about said one at least rooms.

SubPara.49. A projected light system of 47 or 48 wherein said rooms a part of a residential dwelling or an office.

SubPara.50. A projected light system of 1 through 25 for use in facilitating selection of one item from another item wherein both items are stored in luggage.

SubPara.51. A projected light system of 1 through 25 for use in directing a person to a seat in a public place.

SubPara.52. A projected light system of 1 through 25 for use in directing a person to a motor vehicle.

SubPara.53. A projected lights system of 52 wherein said location is a parking place for said vehicle in a car park.

SubPara.54. A projected light system of any of 1 through 25 for use in selecting a particular book from a plurality of stored books.

SubPara.55. A projected light system of any of 1 through 25 for use with a board game wherein said projected light indicates the location for a player to move a game piece and or said projected light forms an image of the game piece at said location.

SubPara.56. A projected light system of 55 wherein said image of the game piece is a hologram.

SubPara.57. A projected tight system of 55 or 56 wherein the projected light is used to sequentially indicate one at least locations from a present location of a game piece to a destination location for the game piece.

SubPara.58. A projected light system of claims 55, 56 or 57 wherein the position of said projected light is computer controlled.

SubPara.59. A projected light system of 58 wherein said computer is coupled to means that determine the progress of said game.

SubPara.60. A projected light system of 59 wherein said means for determining the progress of said game include information related to one at least dice.

SubPara.61. A projected light system of 60 wherein said dice are known art manually thrown dice.

SubPara.62. A projected light system of 61 wherein the result of said throw is determined by computer controlled means.

SubPara.63. A projected light system of 62 wherein said information is acquired by digital imaging means.

SubPara.64. A projected light system of 60 wherein said dice are electronically synthesized dice.

SubPara.65. A projected light system of 59 wherein said means that determine the progress of the game include information related to chance and or community chest in a game of monopoly.

SubPara.66. A projected light system of 59 wherein said means that determine the progress of the game include information related to one at least squares on a monopoly board.

SubPara.67. A projected light system of 59 wherein said means that determine the progress of the game include information related to one at least cards relating to a property on the monopoly board.

SubPara.68. A system for use with a game of monopoly played on a board or on an image of a monopoly board comprising: the coupling of a computer to information related to one al least of the i) outcome of throwing a dice, ii) chance cards, iii) community chest cards, iv) instructions on one at least board positions, v) property cards, wherein said information is used to selectively highlight a position on the board related to a player's game piece.

SubPara.69. A system for use with a game of monopoly of 68 wherein one at least of dice, chance cards, community chest cards, property cards or board information are provided in part at least by electrically operable means.

SubPara.70. A system for use with a game of monopoly of 68 or 69 wherein said position is highlighted by projected light.

SubPara.71. A system for use with a game of monopoly of 70 wherein the projected light is provided by a laser.

SubPara.72. A system for use with a game of monopoly of 70 wherein the projected light is provided by light focused to particularly facilitate said selective highlighting.

SubPara.73. A system for use with a game of monopoly of 70 wherein said projected light comprises a plurality of computer controlled pixels.

SubPara.74. A system for use with a game of monopoly of 68 through 73 wherein the relationship to the players piece is the position for said piece to be moved to.

SubPara.75. A system as disclosed in any of one through 68 adapted for use with other board games.

SubPara.76. A computer coupled to a means for providing information from the throw of a manual or electronic dice (or equivalent) wherein said information is processed by the computer for directing projected light to one at least locations on a board game.

SubPara.77. A computer coupled to the means of 76 wherein said board game comprises one at least of monopoly, ludo, squatter, snakes and ladders.

SubPara.78. A computer coupled to a means for receiving information related to a bingo draw including means for processing this information, to direct a projected light means to a number on a player's bingo card.

SubPara.79. A computer coupled to a means for selectively illuminating houses and or hotels on (or associated with) a monopoly board.

SubPara.80. A computer coupled to a means of 79 wherein projected light illuminates 3d embodiments of houses/hotels.

SubPara.81. A computer coupled to a means of 79 wherein said houses/hotels are 3d projected holograms.

SubPara.82. A digital imaging means for use with a container of plural pieces of confectionery for use in facilitating the identification of a particular piece of said confectionery.

SubPara.83. A digital imaging means of 82 wherein the imaging means identifies the position of a movable visible means relative to at least one said confectionery pieces.

SubPara.84. A digital imaging means of 83 wherein said visible means includes one at feast human fingers.

SubPara.85. A digital imaging means of 82, 83 or 84 wherein said identification is used to provide information related to said confectionery piece.

SubPara.85. A digital imaging means of 82, 83, 84 or 85 further coupled to one at least other means disclosed in the specification for storing confectionery.

SubPara.87. A digital imaging means of 82, 83, 84, 85 or 86 wherein said confectionery comprises pieces of chocolate.

SubPara.88. A system for measuring the amount of at least one substance to add to a container, said system comprising the projection of light to mark a level in the container to which to add said substance.

SubPara.89. A system for measuring the amount of at least one substance of 88 wherein said projected light is provide by one at least of a laser, focused light, light comprising a plurality of computer controlled pixels.

SubPara.90. A system for measuring the amount of at least one substance of 88 or 89 wherein the substance is an ingredient in a mixed drink.

SubPara.91. A system for measuring the amount of at least one substance of 90 wherein said mixed drink is an alcoholic cocktail.

SubPara.92. A system for measuring the amount of at least one substance of 88 or 89 wherein the substance is part of a food recipe.

SubPara.93. A system for measuring the amount of at least one substance of 88 through 92 wherein the level of the projected light relative to the container is computer controlled.

SubPara.94. A system for measuring the amount of at least one substance of 88 through 93 further coupled to computer accessible information related to the amount of said substance to add to a mixture of a plurality of substances.

SubPara.95. A system for measuring the amount of at least one substance of 88 through 94 wherein said projected light level is set to a first level for a first substance of a mixture and positioned to a second level to indicate the amount of a second substance to add to the mixture, said second level above said first level.

The invention preferably may consist of and or include any part at least of any of the disclosures in this specification.

A non-limiting objective of the present invention is to provide for a preferably computer controlled projection system for projecting a signal comprising light for indicating, for example:
1) one at least locations and or storage means for: a) the placement of at least one object, and or b) location of at least one object at the location and or storage means, and or c) an action on at least one object at said location/storage means and or c) the retrieval of at least one object from said one at feast location/storage means and or; and or
2) one at least objects: a) for placement at one of said locations/storage means and or b) for actioning at one of said locations/storage means and or c) for removal from said location/storage means; and or
3) the location of an object.

The object preferably may be inanimate (eg bottle of wine, container of ingredients for a mixture, socks, garments, keys, item in a retail store, mobile phone, bunch of keys) or animate (eg a person).

Said indication is preferably for selective indication of one at least locations, and or storage means, and or object from one at least other locations and or storage means and or objects and or means. Said selective indication of a particular location(s)/object at a first time preferably may comprise a projected signal that is distinct to a projected signal for said particular location/object at a second time (for example a storage location in a wine cellar may have red light projected to a storage location a first time and green light projected a second time).

Said signal preferably may be inactivated eg for stopping said selective indication.

The preferred light is visible light however any frequency is preferably allowed. Typically it may be a person placing/actioning/retrievtng said object(s) and light of visible frequencies may be preferred. In other embodiments ultraviolet and or infrared frequencies preferably may be used. For example, a person may view the signal through a device to convert ordinarily non-visible (to a human) frequencies to visible light (for example using known art means to convert IR to visible light). The illumination of locations/storage means/objects is preferably not restricted to use for humans. For example a robot means may seek locations/objects by seeking one or more illuminated areas. Said robot preferably may be able to detect one at least of:
U/V, Visible, IR and or other frequencies directly or indirectly with an imaging means.

Although the term “visible light” may be used in this description it is preferably also intended to refer to other types of electromagnetic radiation allowed for by the invention (eg said U/V and or IR) where appropriate.

The invention preferably includes means for projecting information (eg. one a least of: text, colour indicia, graphics, static images, moving images) onto part at least of said Location and or Storage Means and or Object (also collectively referenced in this specification as LSMO).

Selective indication of at least one LSMO is preferably by projection of the signal onto part at least of said LSMO(s) and or means proximal to said LSMO(s) such that the projected signal distinguishes the LSMO(s) and or proximal means from at least one other LSMO and or other means.
As a non-limiting example, a preferred signal is the illumination of part at least of one at least LSMO(s) and or means proximal to said LMSO(s) such that said LSMO(s) and or means proximal to said LSMO(s) are distinguished by one at least projected: colours, and or shapes, and or indicia, and or text, and or graphics and or images (moving and or static) and or intensities of light and or varying intensities of light over time (eg red circle flashing twice per second) from one at least other LSMO(s) and or other means.
It is preferable that said signal in part at least may comprise one or more parts (eg area and or region) of reduced and or no intensity of illumination of part at least of one at least LSMO(s) and or proximal means, compared to one at least other LSMO and or means proximal to said other LSMO′ and or other means, (for example a wine cellar may store a plurality of bottles and for a person looking for a bottle from said plurality of bottles, the bottles and or their associated storage location that are not required may be illuminated and the desired bottle/storage means may be dimly illuminated or not illuminate by projected light).

The means for projecting light (projector means) are preferably not limited.

Preferred examples may include:
1) One at least laser means arranged for projecting one or more colours for providing said selective indication. It is preferable for example that the laser beam may be a point of light and or diffused in part at least (for example the effects permitted by known art laser pointers). It is preferable for example that the laser beam may be arranged for drawing patterns (eg one at least text, and or graphics, and or indicia, and or shapes) in one or more colours. The laser light preferably may be directed at one or more LSMO's a first time and one at least other LSMO's a second time. It is preferably that a plurality of LSMO's may be concurrently (at least as perceived by a person) indicated by one or a plurality of laser beams. and or
2) One at least known art spotlight means arranged to project light for providing said selective indication, and or
3) One at least image projector means, for example the Microvision “Pico Projector”. For example an image projector may be made to project an image comprising one or more circular areas and or outlines onto one or more bottles stored in a wine cellar leaving other bottles illuminated by the ambient lighting. It is preferable that at least one bottle may be illuminated a first colour and a second bottle a second colour. It is preferable that other information may be projected (eg the name and or vintage of the wine in said bottle(s). As the projector is preferably essentially outputting what may be displayed on a computer display of similar resolution a dynamic image display system may be readily implemented for identifying LSMO's.

It is preferable that the output of plural projecting means may be coordinated (eg by said computer).

It is preferable that the LSMO's that a projector means may be for signalling, may vary from one time to another. For example at a first time a projector (“first projector”) may be for signalling a plurality of LSMO's and at a subsequent time one or more of said plurality may not be accessible for said projector (eg a person or object may be obstructing the projection path to an object, eg bottle of wine in a wine cellar or a box of soap powder in a supermarket) and one at least other projector means may be required to project the signal for part at least of said plurality.

It is preferable that the projection angle of one at least projection means may be varied.

It is preferable that at least one projector means (“first projector”) may provide projected light for a region (“first region”) comprised of one or more LSMO's and at least one projector (“second projector”) may provide projected light for a region (“second region”) comprised of one or more LSMO's and preferably at least one projector (“third projector”) may provide projected light for a region (“third region”) comprised of one or more LSMO's It is preferable that LSMO's of the first and second region may include one at least LSMO's distinct to the first region compared to the second region and or one at least LSMO's distinct to the second region compared to the first region and or one at least LSMO's common to both regions. It is preferable that the third region comprises LSMO's distinct and or common to LSMO's of the first and or second regions. It is preferable that the LSMO's for a particular region may vary.

Non-limiting examples of applications for the invention preferably may include:—
1) Locating/Placing/Retrieving/Actioning/Rearranging/Selecting one or more bottles of wine stored by a wine storage/cellaring means.

The invention incorporates by way of reference previously published PCT AU05/00375 (“0375”) “Automated wine cellar” by the present inventors. It is preferable that the visible indicator means described for said “0375” may be replaced in part at least by the Computer Controlled Projection Means of the present specification. It is preferable that other means described for “0375” may be implemented in part at least by means disclosed in the present specification. It is preferable that means disclosed in “0375 may be used to provide part at least of the means of the present specification. It is preferable that the section indicator of “0375” may be implemented using a projected light. Furthermore, the means for selecting other stored beverages (eg alcoholic beverages for use in preparing alcoholic cocktails preferably may be implemented in part at least using projected light for selective indication. It is preferable that projected light may be used for locating chocolates and or other confectionary items (eg selecting the confectionery/chocolate from plural candies/chocolates stored in a box). It is preferable that projected light may be used to selectively indicate an edible item in a box of chocolates from at least one other item. It is preferable that projected light may be used to provide an graphics/text/indicia/image (moving and or static) on part of a box of chocolates/candies and or one at least of said chocolates/candies. Said projection preferably may comprise an animated greeting card. It is preferable that projected light may be used to provide an image/text/indicia/graphics onto a package (eg of food) and or a container for drink (eg name person drink for, name of drink, ingredients of drink). For example a drinking glass may have an area of opaque glass/plastic for a screen for the projected image. For example a laser may be used to “write”/project onto a drinking glass (preferably not modified to provide a screen area). It is preferable that the projected light source may be used for selecting a package of food from a plurality of packages (said packages preferably distinct or the same). It is preferable that projected light may be used to facilitate preparation of a mixture from any ingredients, for example an alcoholic cocktail, or a non-alcoholic beverage or a mixture of food and or beverages. Projected light means preferably replace part at least of the visible indicator means disclosed in “0375” for selecting one or more ingredients for one or more mixtures.

It is preferable that the fluid level indicator of “0375” may be implemented by projecting light onto and or from the container for preparing the beverage and or means proximal to said container and or contents of the container. For example, a laser may be arranged to draw a line at a first level for a first ingredient and a second level for a second ingredient. Multiple levels preferably may be drawn concurrently, preferably a first level for a first ingredient and a second level for a second ingredient. Various images (static/moving), graphics, text, and or indicia preferably may be projected onto the container and or proximal means and or the contents of the container. It will be appreciated that the use of an image projection means may be used with or without the laser for providing said fluid level indicator and or said various images. Known art means for projected light may produce the appearance of 3d Shapes (eg cone of light inside the container generated by a laser beam). It is preferable that a hologram may be used for part at least of said fluid level means and or images on/in a container (eg cocktail shaker, drinking glass. It is preferable that a beverage and or meal may be provided to a person coupled to a means for projecting and or otherways causing images, laser drawn text/graphics, hologram to be associated with (eg projected onto/from): the container/and or other apparatus (eg plate) for said beverage/meal, and or said beverage/food and or means proximal to said beverage/food. Projected information preferably may include details about said person (eg name) information about food/beverage (eg cocktail name) of the information disclosed in “0375”.

2) A means for locating stored books and or documents. It will be appreciated that the means described for “0375” may be adapted for use in locating books (eg on a bookshelf or in a library).

3) Sorting socks into matching pairs may be facilitated by a projected light for indicating a location to place socks during the sorting process. PCT AU05/00256 (“0256”) “Electronic sock sorting and mating system” by the present inventors is incorporated into this specification by way of reference. It will be appreciated that a projected light means may be used to provide the illuminable indicators of “0256”. It is preferable that text (eg name of person associated with the sock), indicia, images (moving/static), graphics may be projected onto the location for the sock and or onto the sock at the location. It will be appreciated that the mating of socks may be applied to the mating of other item (said items preferably not limited). The means of “0256” preferably may be adapted to sorting other items into sets (eg gloves, stockings, garments for a particular person from those for another person). It will be appreciated that the imaging means of the present invention preferably may be used to image items for sorting (eg socks) to facilitate identifying the item and determining placement of the item at a location and or removal of the item from a location.

4) Locating a stored key from a plurality of keys. PCT AU03/001029“Identification and selection of keys for use with locks” and PCT AU05/000242 “Enhanced automated key selection system” are incorporated by reference into this specification. Projected light preferably may be used for part at least of the visible indicators of “1029” and or “0242” and or other known art key locating means using electrically operable indicators arranged for selective illumination of a key and or means proximal to said key.

5) Locating an item stored (eg on a shelf) in a store (eg bottle shop, supermarket).

6) Locating a misplaced item—known art means for locating misplaced items (eg a bunch of keys) disclose the attachment of an electrically operable visible and or audible means to the object. It is preferable that the projected light means may be used to indicate the position of a misplaced/lost object by projecting light onto said object and or proximal to the object—for example the object may have an electronic means to transmit its position (eg GPS or other position determining means) to an electronic means coupled to the projection means for directing the projected light to the object and or means proximal to the object

7) A projected light may be used for directing a person (eg to a cinema/theatre seat).

It is preferably that any one or more of the means described for said “0375” and or “1029” and or “0242” and or “0256” may be incorporated into the means of the present invention and part at least of means of the present invention preferably may be incorporated into said “0375” and or “1029” and or “0242” and or “0256”.

The invention is an advance of the known art for visually highlighting an LSMO and or means proximal to said LSMO. Said known art comprises one at least light emitting/producing means attached to the LSMO and or means proximal to said LSMO. For example, a wine cellar may include a LED inside a storage receptacle for a bottle of wine that is arranged to illuminate for identifying the location of the bottle.

Known art light sources are also fixed in position with reference to their connection means. Known art light emitting mean for use in identifying objects do not disclose means for moving the emitting means and or altering the path of light from the emitting means under computer control (in particular a computer controlled electromechanical means for repositioning the light emitting means and or the path of light from said means). For example, bottles in a known art wine cellar may be selectively indicated by light sources Fixed in position to the storage means and or the wine bottle, A means to reposition the light source or redirect the emitted light under computer control is not disclosed. Known art means for locating a key stored in a system for storing a plurality of keys have similar limitations. The known art describes an illuminable indicator attached to a key that clearly moves when the key is moved however said movement is not computer controlled (in particular a computer controlling an electromechanical means for causing said movement). Known light assisted object location/placement means typically include the use of one at least electrically illuminable means for each storage location for an object and or each object. In the case of a wine cellar or a retail environment the number of light emitting devices may be considerable.

The present invention preferably reduces the number of light emitting means by allowing a light source to be arranged for indicating a plurality of LSMO's and in particular preferably a first of said plurality a first time and a second of said plurality a second time wherein the signal is proximal to the first LSMO the first time and proximal to the second LSMO the second time wherein the first proximity is distinct to the second proximity.

For the present invention it is preferably that the projection of light for selectively indicating one at least LSMO's is a response to an input signal related to the LSMO and or means proximal to the LMSO.

Projected light preferably may includes one at least of the following examples:
laser light;
light projected and/or focussed onto one at least LSMO's and or proximal means;
path of light is modified (eg redirected), for example by at least one of a reflecting means (eg mirror), lens, prism, and/or beam splitter;
light conducted using fibreoptic means (eg cable);
light from a light generating device that is located remote to the LSMO's for selective indication;
light from a projecting means that has its path of travel modified by movable means (eg mirror, lens, prism) wherein said movement is preferably controlled by a computer and/or electrically operable means (eg motor, piezoelectric);
light from a projecting means eg semiconductor laser, image projector (eg said Microvision Pico Projector) wherein the means is re-positionable, preferably using computer controlled and/or electrically operable means (eg motor, piezoelectric, Shape Memory Alloy, solenoid means)

In a preferred embodiment a single light source (eg a laser beam) may be positioned to highlight at least a first storage location/object at a first time and a second storage location/object at a second time, the first and second locations preferably not adjacent.

The system preferably may be comprised of physically discrete devices. It is preferable that discrete parts of the system may be coupled by wired and/or wireless means. It is preferable that discrete parts of the system may be coupled by a WAN (for example: the Internet).

The system preferably further comprises a sound input means (eg microphone) to receive voice information (eg commands) and preferably voice recognition means (eg DSP and/or software).

The system preferably further comprises a key board means of at least one key to provide for user input of information.

The system preferably further comprises a pointing device (eg mouse, touch screen, light pen).

The system preferably further comprises an electrically operable display (eg LCD, OLED) that is preferably a colour display. The display is preferably arranged to output information. The display is preferably arranged to provide for input of information by a person. Non-limiting examples of said display input preferably included at least one of: user selection of displayed menus, text and or graphics, touch screen.

The system is preferably responsive to voice commands.

The system preferably further comprises an image capture means/apparatus, for examples a digital camera (eg using CMOS imaging technology). The light emitting system is preferably further coupled to an image processing means (eg DSP and/or software). The image capture means/apparatus is preferably operative in the control of said output signal. As non-limiting examples, said image capture preferably may facilitate one at least of:
determination of a vacant and/or available location to place an object;
determination of an object, and or object stored at a location and or an object for storage at a location;
identification of an object (for example, a key or wine bottle may have an attached colour coded ID that the imaging system may capture and cross reference with electrically stored information related to the ID);
determination as to whether a person is looking at a source of laser light (preferably causing the inactivation of the laser and/or redirecting the beam until this potential risk is resolved),
[symbol] resolved);
determining the location of a person and or thing with respect to one at least LSMO's
positioning of one at least objects;
monitoring the progress of a process (eg a person preparing an alcoholic cocktail);
acquiring information from an object (eg reading information (preferably including barcode information) from the label of a wine bottle, reading a sock ID woven into the sock; reading indicia attached to a key);
acquiring information from a) id means attached to the storage means, and or b) and or storage means, and or c) an object and or d) LSMO and viewing the position of a projected-light relative to said a) and or b) and or) and or d) facilitate re-positioning of the projected light (eg to illuminate said LSMO).

The system preferably further comprises a means to read bar codes (eg bar code reader).

The system preferably further comprises a means to provide accessory lighting functions—for example:
a child's night lamp, and/or
means to project/draw lighted patterns on the ceiling and/or walls and/or floor and/or items in room.

Said accessory light function preferably may be further augmented by sound.

Non-limiting examples of said objects preferably may include at least one of: bottles (and/or other containers) of wine; bottles (and/or other containers) of alcoholic and/or non-alcoholic beverages (eg. for use in preparing preferably alcoholic cocktails); socks; lock keys (preferably including single keys and/or keys grouped together by a key grouping device—eg a key ring); chocolate (eg individual pieces) and/or candy; supermarket items; household items (preferably fixed and mobile); consumer items (eg keys, cellular phones, portable phones, PDA); and/or an item of clothing (eg lingerie, dress, trousers, tie, shoes, belt).

The storage of at least one object is preferably temporary and/or reversible.

Non-limiting examples of said storage means preferably may include one at least of: wine storage apparatus (eg. wine rack, wine cellar); shelf (eg storing containers of beverages and or supermarket items), a surface (eg table top for sorting socks into pairs), a prepared surface (eg plastic sheet with printed imagery); wall mounted apparatus to hold keys (eg using hooks); part of a building; furniture; seat for a person.

A preferred signal comprises laser light and/or focused light (eg a spotlight) and or an image from an image projector. The light is preferably projected onto the storage apparatus and/or an object stored by the storage apparatus. For example:
1) A signal may be projected by the system onto part of an object stored by the storage apparatus; and/or
2) A signal may be projected by the system onto a surface for storing an object; and/or
3) A signal may be arranged to form a shape reflected from said object and/or surface, non-limiting examples of said shape generation preferably may include:
   a) directing the light for the signal through a lens/mask arrangement forming a shape for projection onto said object/surface, and/or
   b) mechanically moving (preferably at high speed) the laser generator (eg semiconductor diode) such that the beam traces out a pattern, and/or
   c) reflecting the light for the signal off a movable mirror (eg spinning, and/or oscillating back and forth) to trace out a pattern, said pattern tracing preferably facilitated by computer controlled switching of the laser on/off to achieve the desired pattern, and/or
   d) directing the light for the signal through a beam splitter, and/or
   e) using the laser light in conjunction with a holographic recording to form a hologram (preferably a projection hologram); and/or
4) A spotlight and/or focused light may be projected onto the object and/or part of the storage apparatus visibly associable (preferably distinctly associable) with the object, said spotlight preferably may be directed through a gel to produce a characteristic pattern and of colour(s); and/or
5) The storage apparatus and/or object may have a light modifying device fitted to facilitate reflection of system light striking said device (for example a mirror, a reflector (eg multifaceted); and/or
6) The light emitted by the system may be used to control further light output from the storage apparatus and/or object (for example, a laser beam may strike a solar cell that is attached to the object and/or storage apparatus—said cell powering an LED, and/or the laser beam may regulated the resistance of a light dependent resistor used to regulate current to an LED).

The signal preferably comprises laser light and or projected image.
The preferred source of laser light includes one at least semiconductor laser diodes.
The system is preferably further arranged to output laser light of at least one distinct colour (for example, red and/or green and/or blue laser light).
The system is preferably further arranged to output a first colour (eg red) directed at a first object and/or first part of the storage apparatus at a first time and a second colour (eg blue or green) directed at a first object and/or first part of the storage apparatus at a second time.
The system is preferably further arranged to output a first colour (eg red) directed at a first object and/or first part of the storage apparatus at a first time and a first colour directed at a second resolved),
determining the location of a person and or thing with respect to one at least LSMO's
positioning of one at least objects;
monitoring the progress of a process (eg a person preparing an alcoholic cocktail);
acquiring information from an object (eg reading information (preferably including barcode information) from the label of a wine bottle, reading a sock ID woven into the sock, reading indicia attached to a key);
acquiring information from a) id means attached to the storage means, and or b) and or storage means, and or c) an object and or d) LSMO and viewing the position of a projected light relative to said a) and or b) and or) and or d) facilitate re-positioning of the projected light (eg to illuminate said LSMO).

The system preferably further comprises a means to read bar codes (eg bar code reader).

The system preferably further comprises a means to provide accessory lighting functions—for example:
a child's night lamp, and/or
means to project/draw lighted patterns on the ceiling and/or walls and/or floor and/or items in room. Said accessory light function preferably may be further augmented by sound.

Non-limiting examples of said objects preferably may include at least one of: bottles (and/or other containers) of wine; bottles (and/or other containers) of alcoholic and/or non-alcoholic beverages (eg. for use in preparing preferably alcoholic cocktails); socks; lock keys (preferably including single keys and/or keys grouped together by a key grouping device—eg a key ring); chocolate (eg individual pieces) and/or candy; supermarket items; household items (preferably fixed and mobile); consumer items (eg keys, cellular phones, portable phones, PDA); and/or an item of clothing (eg lingerie, dress, trousers, tie, shoes, belt).

The storage of at least one object is preferably temporary and/or reversible.

Non-limiting examples of said storage means preferably may include one at least of: wine storage apparatus (eg. wine rack, wine cellar): shelf (eg storing containers of beverages and or supermarket items), a surface (eg table top for sorting socks into pairs), a prepared surface (eg plastic sheet with printed imagery); wall mounted apparatus to hold keys (eg using hooks); part of a building; furniture; seat for a person.

The system is preferably arranged to receive an input signal that as a non-limiting example is related;
to an object, and/or
storage receptacle and/or storage location for an object, and/or
the storage apparatus.

The input signal is preferably processed by an electronic data processor (eg microprocessor, DSP, and/or said system computer) that is preferably coupled to the light emitting system. The system is preferably responsive to said input signal, said response preferably including control of one at least light projecting devices and or means affecting the light produced by said light projecting device.
object and/or second part of the storage apparatus at a second time, said first and second object preferably distinct objects and/or said first and second parts of the storage apparatus preferably distinct to each other.
The system is preferably further arranged to output a first colour (eg red) directed at a first object and/or first part of the storage apparatus at a first time and a second colour (eg green) directed at a second object and/or second part of the storage apparatus at a second time, said first and second object preferably distinct objects and/or said first and second parts of the storage apparatus preferably distinct to each other.
The system is preferably further arranged to facilitate the mixing of a plurality of different coloured laser light to cause at least one colour distinct to the colour components of the mix to be reflected from said object and/or the storage apparatus (for example, red and green and blue laser light may be directed onto a stored object with the final mixed colour preferably determined by the intensity and or length of time of a pulse and/or frequency of pulses of one at least colours of laser light contributing to the mix (eg adjusted to produce a pinkish-orange or light blue).
   The electronic mixing of light of different colours is known to the art.

The means for projecting light preferably further comprises one or more:
lenses to focus the light, and/or
mirrors (and/or other reflecting means) to otherwise modify the path of the light, and/or and/or beam splitters,
   preferably wherein at least one of:
      said lens, and/or
      said mirror, and/or
      said laser, and/or
      beam splitter, and/or
      other means affecting the path of light produced by the system, movable using automated means (that preferably include electromechanical means—eg motor, solenoid, or piezoelectric), said automated means preferably computer controlled.

The system preferably further comprises a means to determine if a person (and/or animal) may be exposed to laser light (eg in a potentially harmful manner—for example, if they are looking at the source of the laser light (eg the semiconductor diode) and/or a mirror or lens redirecting the laser light).

The system preferably detects a person or thing obstructing a path for a projected light to a LSMO. The system preferably includes means to compensate for said obstruction eg. recruiting the use of one or more means for projecting light and or modifying the image and or path of light projected from one at least projection means.

The preferred arrangement includes the use of a digital imaging system (eg digital camera) preferably fixed in proximity to the output of the laser that uses digital image processing to determine the whether of not one or more eyes are looking at a laser beam an/or are at risk of doing so. In at risk situations it is preferably that precautions are taken to minimise or eliminate the threat of eye (or other) injury. Said risk minimisation preferably includes, as non-limiting examples:
switching the laser off and/or not activating the laser if activation is pending, and/or redirecting the laser light (eg using a mirror), and/or reducing the intensity of the laser beam and/or reducing the time of exposure to the beam.

The digital imaging means preferably may also be used to locate the position of objects or persons with reference to LSMO's. The computer preferably includes means (eg software) to compensate in part at least for the presence of said person/thing.

The digital imaging means preferably may receive information related to the position of at least one projected signal relative to one at least LSMO's and or other means, said system preferably for using said received information for facilitating repositioning of the projected light.

The system preferably comprises a means to receive information from a storage means for objects, said information: related to placement, and or removal, and or movement of one at least objects with respect to an associated storage location/means. For example a switch means and or RFID means and or One Wire means may detect placement and or removal of an object. It is preferably said imaging means may then be caused to focus on the associated object/location—eg see if actually or placed, attempt to read id means and or label information attached to the object. Information acquired by said imaging means is preferable provided to the computer (and or other means) for updating electronically stored information relating to the LSMO.

It is a non-limiting objective of the invention to disclose a length of conducting means and or substrate means, wherein, one at least of said conducting means/substrate means is for coupling to one at least components, said components) for use with a wine storage means comprising a plurality of storage locations each location for storing at least one container of wine. It is preferable said conducting means comprises one at least electrical and or optical conductors. It is preferable that one at least components are attached/bonded/integral to said length of conducting material/substrate. The conducting means/substrate means together with any attached/bonded/integral components(s) are referenced as a length means in this specification: The length means is preferably a strip.

Non-limiting examples of said attached/bonded/integral preferably may include one at least of:
a) soldered,
b) conductive glue/epoxy,
c) printed (and or in otherways deposited), preferably onto the'substrate,
   (for example OLEP and or polymer semiconductors may be screen printed or reel to reel printed onto the substrate (eg polymer) and or other means.

Non-limiting examples of substrate preferably may include FR4 fibreglass and or polymer means (eg as used for producing a Printed Circuit Board). The substrate is preferably flexible (for example a flexible PCS using known art mylar and or other polymer means). The substrate preferably may be folded (eg to provide for a right angle turn). The substrate and any coupled means are preferably thin (eg less than 4 mm or less than 3 mm or less than 2 mm or less than 1 mm). Non-limiting examples of a flexible substrate preferably may include one of the means used for producing a flexible OLEP and or OLED display as known to the art (add-vision discloses examples of flexible polymer OLEP displays at www.add-vision.com). Toppan Printing (Japan) also produce flexible light emitting polymers.

A storage location is preferably defined by a physical means separating part at least of the storage location from adjacent storage locations and or other means (eg objects not part of the wine storage means). Non-limiting examples of the physical means preferably may include a partition (eg wall) and or rails for supporting a wine storage container and or vertical and or horizontal structural members of the wine storage means.

A typical container of wine preferably comprises a bottle of wine however it is preferable that the ward container may be understood as referring to any suitable container and or mix of containers suitable for storing wine. The term bottle of wine is preferably interchangeable with the term wine storage container. A typical wine storage means preferably includes a wine cellar.

A preferred arrangement for a length means is a strip. Said strip preferably has essentially parallel sides. It is preferable said length may not be straight. It is preferable the width and or thickness and or planarity of said length of substrate may vary along the length.

It is preferable that the length of substrate is sufficient to couple to means proximal to a plurality of storage locations. For example for storage locations in a vertical configuration it is preferable that a length means may extend from any one storage location to any other storage location. For storage locations in a horizontal arrangement it is preferable that a length means may extend from any one storage location to any other storage location.

It is preferable that a length means coupled to a wine storage means may traverse a plurality of directions, for example: up a vertical support member, across a horizontal support member and then from front to back along a rail for supporting a bottle of wine. The preferred embodiment is for a length means to approximately at least traverse a single direction (eg vertical) and then interface with a connector to couple with: a second length means for traversing a second direction (eg horizontal) and or an IC (eg for providing control signals) and or other electronic device.

It is preferable that said conducting means may comprise one or more discrete conductors (electrical conductors) (eg bare or insulated wires)/optical conductors) (eg fibreoptic means) however, it is preferable that the conducting means comprises one at least conductors attached to the substrate means of a length means.
For example it is preferable that one at least electrical conductors are bonded to the substrate of a length means. It is preferable that said bonded electrical conductors) and substrate comprise part at least of a printed circuit board. It is preferable that said bonded electrical conductors) may be produced by i) selective etching of metal (eg known art PCB production) and or ii) printing and or other deposition of conductive ink and or conductive polymer.

Non-limiting examples of a component coupled or for coupling to said length of conducting means/substrate means preferably includes one at least of:
1) electrically illuminable means;
2) LCD;
3) electronic paper/electromechanical display;
4) an electronic device (eg resistor, inductor, capacitor, solenoid, IC, memory means, CPU, FPU, DSP, Image Processor, Voice Processor);
5) electrically operable imaging means (eg CMOS imaging means/CCD means);
6) means for detecting the presence/absence of a container of wine in/from the wine storage means (for example a photo-emitter means/photo-detector means);
7) electrically operable locks/latch means (eg coupled to a door or other means to limit access to a storage location);
8) laser (eg one at least semiconductor laser diodes);
9) electrically operable tight projecting means;
10) electrically operable motor means;
11) digital thermometer;
12) electrically operable cooling/thermo-regulation means;
13) connector means;
14) electronic display comprised of a plurality of pixels in horizontal and vertical arrangement for displaying text/graphics/images;
15) wireless means (eg for providing control signals to one at least said components).

It is preferable that one at least electronic devices may be fabricated in part at least from polymer semiconductors that are preferably deposited (eg printed) as a thin film onto the substrate.

Non-limiting examples of connector means preferably include one at least of:
a) plug and or socket (eg known art plug or socket for coupling electronic devices), and or
b) one or more ‘conductive fingers’ (for example, known art PCB edge connectors) for mating with a suitable means (eg a socket).

One at least connector means preferably may be located at one at least ends of a length means.

One at least connector means preferably may be located along the length means.

It is preferable that one at least components are coupled (preferably reversibly) to a length means using a connector means (eg the a connector means of the preceding paragraph). It is preferable that one at least components are coupled (preferably reversibly) to a length means by another length means. It is preferable that one at least components are coupled (preferably reversibly) to a length means using a second component (eg CPU). It is preferable that one at least components and or a first length means are coupled to a second length means by bonded coupling (eg soldering).

It is preferable that the connector provides for conductive coupling between at least one electrical conductor coupled to the substrate (eg by attachment and or deposition on the substrate—eg printing) and an electrical conductor coupled to another means (eg a second length means and or an electronic component—eg IC, resistor, capacitor, light emitting device, or electronic paper).

It is a non-limiting objective of the invention to disclose a barrier means ton a) separating part at least of the length means from the material (eg wood) of a wine storage means and or b) positioning part at least of the length means (eg to cause light to be emitted from a length means in a particular direction) and or c) facilitating coupling of a length means to the wine storage means/barrier means and or d) facilitating removal of the part at least of the length means from the wine storage means/barrier means.
It is preferable that a length means is coupled to the wine storage means using an arrangement that provides a barrier means between part at least of the length means (and preferably any coupled means) and material of the wine storage means (for example a combustible wooden support structure). For example, the barrier means preferably may minimise or reduce the risk of a fire in the event of an electrical short between conductors or a defective electronic device. The barrier means is preferably fire resistant and or retardant. The barrier means preferably includes a void for receiving the length means. Non-limiting examples of a barrier means preferably may include a glass and or plastic tube/enclosure. The barrier means is preferably transparent and or translucent in part at least. Examples of a suitable transparent plastic for the barrier means preferably may include the transparent flame retardant plastic ‘Nucycle’ from NEC and Sumitomo Dow. It is preferable that part at least of the barrier means may match the adjacent material of the wine storage means (for example a woodgrain finish except in the areas for: illumination means and or photo emitter means to emit light and or a photo-detector means to receive light (said light preferably including visible/IR/UV)).

It is a non-limiting objective of the invention to disclose a puller means for: a) facilitating coupling of a length means to a wine storage means/barrier means and or b) facilitating removal of the part at least of the length means from the wine storage means/barrier means.
It is preferable that there is a means to facilitate coupling of a length means to a wine storage means, for example: a means to pull (referenced as a ‘puller means’) a length means as it is slid into a barrier means and or groove/furrow/channel in the material of the wine storage means. It is preferable that the puller means may be manually and or electrically operable (for example a motor means). It is preferable that the puller means includes a means to attach (referenced as puller attachment means) to a length means. It is preferable that the puller attachment means includes a reversible means to prevent it from being positioned in an inaccessible location (eg within the void of the barrier mean and or a groove/furrow/channel in the material of the wine storage means). It is preferable that the puller attachment means is unable to be pulled inside the barrier means and or said groove/furrow/channel in the material of the wine storage means unless a person performs a deliberate action and or unless a length means is attached to the puller attachment means. It is preferable that a length means may only be removed from a puller attachment means when the attachment means is in an accessible location and further preferable that said removal of the length means prevents the puller attachment means moving to an inaccessible position until reattachment of a length means. A non-limiting reason for restricting use of the puller means is to prevent the puller attachment means from inadvertently sliding (or being pulled) into an inaccessible position where it may interfere with subsequent insertion of the length means and or be inaccessible for use with the length means.

It is a non-limiting objective of the invention to disclose a wine storage means particularly arranged for coupling to at least one length means and or barrier means and or puller means.
The barrier means is preferably incorporated into the wine storage means during construction of the structural elements of the wine storage means. It is preferable that the barrier means may be coupled to the wine storage means after manufacture (eg by sliding the barrier means down a suitable formed channel/groove/furrow or similar in the material of the wine storage means).

It is preferable that a barrier means and or a length means may be attached to the wine storage means such that said barrier means and or length means is elevated from the surface of the material of the wine storage means (for example if the barrier means and or length means is glued to an exposed surface of a structural member of the wine storage means).

The preferred means of coupling a barrier means and or length means to a wine storage means includes: embedding part at least of the barrier/length means in the material of the wine storage means and or attaching part at least of the barrier/length means in a groove/furrow/channel formed in the material of the wine storage means (eg a structural member of the wine storage means). It is preferable that said coupled barrier means and or length means is flush with or below the surface of said material of the wine storage means.

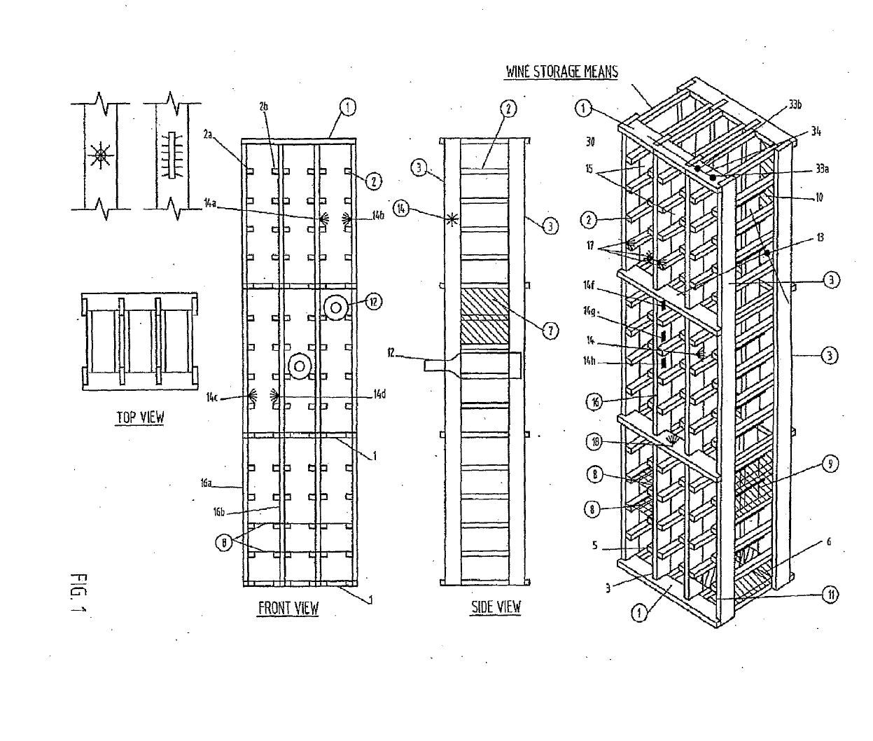

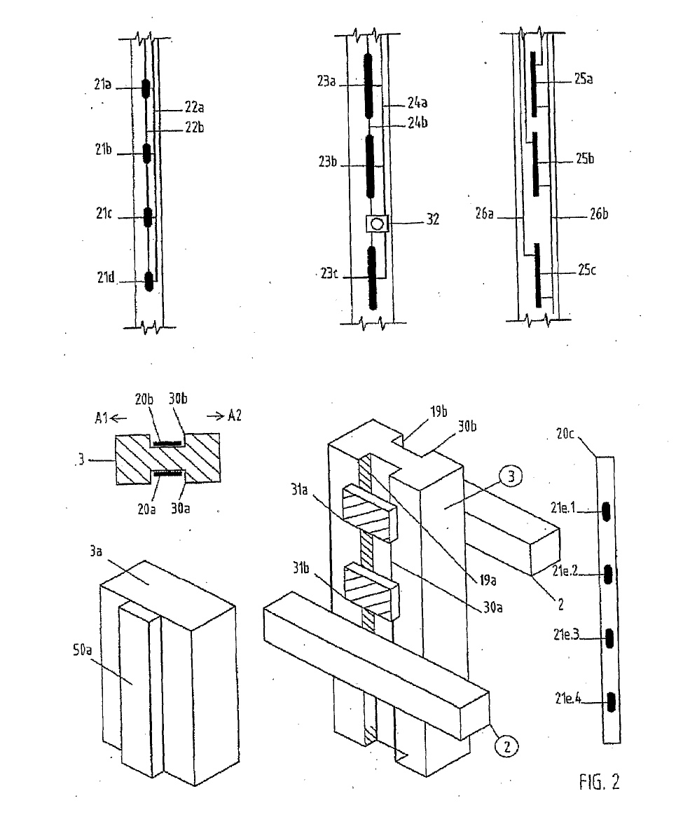

It is preferable that a length means may be attached/coupled to a wine storage means during manufacture of the wine storage means, it is preferable that a length means may be coupled to the wine storage means after manufacture of the wine storage means. Said coupling preferably may be during or after installation of the wine storage means at the customer's premises. A preferred means of coupling a length means to a wine storage means is to slide the length means into i) a void in said barrier means (said void preferably extending at least part of the length of the barrier means) and or ii) a groove/furrow/channel or similar in the material of the wine storage means (eg a groove in a vertical structural member (3 of FIG. 1 of the drawings) of the wine cellar). The length means preferably terminates in a connector means (eg fingers) of conducting material/socket/plug) for coupling (eg at the top/bottom of the wine storage means) with other electrical conductors (eg those of a second length means/electronic device). The length means preferably couples directly/indirectly with a control means (eg microprocessor).

It is preferable that a length means may be removed (in part at least) from the wine storage means subsequent to coupling to the wine storage means. Said removal preferably may be after installation of the wine storage means at a customer's premises. A non-limiting reason for removal preferably may be for servicing/repair/replacement of the length means. Said removal preferably includes sliding the length means from an associated barrier means and or from a channel/groove/furrow in the material of the wine storage means.

It is preferable that the wine storage means is manufactured with one at least channels/grooves/furrows (collectively referenced as channels) formed in the material of the storage means. Said channels preferably for receiving a barrier means and or a length means. Typically if a barrier means is coupled to a wine storage means a length means is preferably inserted into a void in the barrier means rather than directly into the channel.

The channel is preferably essentially straight in length however the shape is preferably not limited (eg it may be curved/bent/vary in width and or depth). The channel preferably may be shaped to facilitate the direction of output or input for one at least means coupled to the length means (eg for aligning the direction of illumination means, photo-diode means, photo-detector means). The channel is preferably deep enough for part at least of the coupled length means/barrier means to be flush with or below the surface of the material that the channel is formed in.

It is a non-limiting objective of the invention to disclose a wine storage means coupled to a length means and or barrier means and or puller means.

It is preferable that at least one said electrically illuminable means is attached (eg soldered/printed/deposited) to a length means and preferably to the substrate of the length means. Said illuminable means is preferably coupled to one at least said conductor means. A plurality of separately illuminable regions are preferably distributed along the length means. Said distribution preferably provides: i) an illuminable region at a first location for association with at least first storage location (and or a container of wine stored at the location) of the wine storage means and ii) an illuminable region at a second location for association with a second storage location (and or a container of wine stored at the location) of said wine storage means and preferably at least: iii) one or more illuminable means at a third location for use with a third storage location (and or a container of wine stored at the location) of said wine storage means. When length means coupled to said illuminable regions is coupled to a wine storage means it is preferable that said illuminable region for association with the first storage location is proximal to the first storage location and said illuminable region for association with the second storage location is proximal to the second storage location and any illuminable region for association with a third storage location is proximal to said third storage location.

It is preferable that at least one illuminable region may be provided by one at least discrete device (eg. LED's). It is preferable that one at least illuminable regions may be provided by an area illumination means (eg OLED or OLEP means deposited onto the substrate in a shape approximating at least the illuminable region (eg a rectangle preferably comprising a curve on each of the narrowest sides)). It is preferable that an illuminable region may be provided by a) monocolour means (eg one of a Red LED or a green LED and or region of monocolour OLEP) or b) multi-colour means (eg bi-colour led (eg red and green LEDs in one package), or c) tri-colour led (eg red, green and blue LEDs in one package), and or d) an illuminable region with at least first OLED/OLEP means for emitting a first colour (eg red) and second OLED/OLEP means for emitting a second colour (eg blue) distinct to said first colour and preferably a third OLED/OLEP means for emitting a third colour (eg green). It is preferable that means for emitting red, green and blue may be arranged to provide multiple colours in addition to the 3 primary colours (eg 16 bit or 24 bit colour means). It is preferable that an illuminable region may be provided by one at least electroluminescent wires (preferably at least a first wire for a first colour and a second wire for a second colour). It is preferable that the illuminable region may be provided by a plurality of vertically and horizontally arranged pixels (eg known art displays—for example 640×400 pixels). Said pixels preferably arranged for providing a plurality of colours, said plurality preferably including red, green and blue and preferably further colours.

It is preferable that one at least electrically illuminable means may provide a decorative function. It is preferable that one at least electrically illuminable means may be for selectively: illuminating and or highlighting and or indicating one at least storage locations from one at least other storage locations. Said selective illumination/highlighting/indicating means may be collectively referenced as ‘selective indication’ in this specification. Said selective indication preferably comprises illumination of means proximal to the associated storage location and or container at said storage location.

It is preferable that part at least of at least one electrically illuminable means may be for displaying information (non-limiting examples: text/graphics/images). For example an illumination means may be used to display the name of a particular type of wine and or vintage and or an instruction. It is preferable that an illumination means may be used to provide said image by back-lighting predetermined information (eg the word “Moselle” may be formed as a transparent region of an opaque means and the illumination means showing through to define the text). It is preferable that part at least of at least one illumination means may be shaped to output said information—for example an OLEP display may be printed in the shape of one or more alphanumeric characters and or graphics and when illuminated output said information. It is preferable that part at least of at least one illumination means may be arranged in an arrangement of a plurality of horizontal and vertical pixels, one at least pixels selectively illuminable to provide at least first information a first time and second information a second time, said first information distinct to said second information. It is preferable that part at least of one at least illumination means may be caused to provide at least a first colour at a first time and a second colour at a second time, said second colour distinct to the first colour. For example, said colours preferably may be selected from one at least of: red, green, yellow, purple, violet, blue, white, pink, orange. It is preferable that an inactivated illumination means does not output light. It is preferable that the inactivated state is a means for providing black. It is preferable that part at least of one at least illumination means may be arranged for providing multi-colour images (eg up to 256 levels of red, green and or blue for up to a 24 bit colour display).

It is preferable that said electronic paper/electromechanical display that reflect light rather than emit light and or said LCD that electronically controls reflected light and or light emitted from a back-light means may be used in place of and or for augmenting the electrically illuminable means. Said replacement/augmentation preferably may be for one at least of the uses and or applications and or means and or combinations disclosed for an illuminable means in this specification.

It is preferable that part at least of a means for detecting the presence/absence of a container of wine in a storage location may be coupled to one at least length means. It is preferable that a photo-emitter (eg narrow beam IR emitter) is coupled to a length means for coupling to a first side of a storage location and that a detector means (eg IR receiver) is coupled to a length means for coupling to a second side of the storage location. It is preferable that the presence of a container in the storage means obstructs and or otherwise attenuates the emitted signal as received by the detector preferably indicating to control means that a container is stored at the location. It is preferable that an empty location permits detection of an unattenuated signal. The invention allows that the emitter/detector are activated/polled periodically. It is preferable that said activation/polling is disabled if no change in storage status is possible/likely (eg a digital imaging means may determine the presence/absence of a person proximal to the cellar, presumably if no-one is about the container storage status is expected (barring the unexpected—eg earthquake) to remain unchanged). The invention preferably allows for an emitter/detector pair for each of a plurality of storage locations.

It is preferable that a length means/wine storage means/barrier means are arranged for positioning a) light from the illumination means in a first direction (eg angled towards the front of the storage location) and b) i) light from an associated emitter of an emitter and detector pair in a second direction (eg at right angles to the side of the storage location, preferably towards a suitably positioned detector) and or ii) the detector to receive light from a means (egemitter) at right angles to the side of the storage location.

Part at least of the present disclosure preferably may be used to implement part at least of the means disclosed in PCT AU2005/000375 “Automated Wine Cellar” by the present inventors. The specification of said 000375 is incorporated by way of reference into, the present specification. For example, the present means for coupling electrical conductors and/or illumination means to a wine storage means preferably may be used to provide the selective indication/illumination for at least one storage location: a) for a bottle of wine and or b) storing a bottle of wine as disclosed in said 000375. It is preferable that the present means for coupling electrical conductors and/or illumination means to a wine storage means may be used for providing a section indicator of said 000375. It is preferable that a length means disclosed in the present specification may be used to provide a wine container presence/absence detector means of said 000375 (eg a IR emitter on one length means on one side of a location for a bottle of wine and a suitable detector on a length means on an opposing side of said storage location). A length means of the present disclosure preferably may be used to provide power and or control and or data and or address signal to an electrically operable lock (eg on a door) for controlling access to one at least storage locations. A length means of the present disclosure preferably may be applied in part at least with the means of said 000375. It is preferable that part at least of the means of 000375 may be applied to part at least of the means of the present specification.

It is preferable that the wine storage means may comprise a plurality of storage modules (said module preferably equating to the Module Receptacle Means of PCT AU2005/000375) wherein each module comprises at least one storage location for storing one at least bottles of wine. It is preferable the wine storage means may be expanded by the addition of at least one said module. It is preferable that means described for the wine storage means and or for use with the wine storage means may be applied in part at least for one at least said modules.

It is preferable that part at least of the means of the present disclosure may be used for storage means for other containers, for example other containers of alcohol (eg cocktail mixers) and or herbs. It is preferable that the term wine storage container may be replaced by the relevant term for another container (eg herb container/bottle or container/bottle of alcoholic mixer drinks) stored by a container storage means using part at least of the present invention. The phrase wine storage means preferably may be replaced by a term referencing other storage means using the means of the present disclosure (for example herb/spice rack or cocktail cabinet). It is preferable that the term ‘wine storage means’ may be replaced by the more generic term ‘container storage means’. It is preferable that part at least of the means of the present disclosure may be applied for storage means for books (wherein the term wine storage container in this specification preferably may be replaced by ‘book’) and the term ‘wine storage means’ replaced by bookshelf.

It is a non-limiting objective of this specification to disclose an imaging system comprising:
at least one electronic camera (said camera preferably comprising at least one CMOS/CCD imaging means and preferably at least one lens means (eg optical lens, fresnel lens, holographic lens and said camera preferably computer controlled (non-limiting examples of said computer control preferably including one at least of: changing direction/position of the camera, changing focal length of the camera, selecting the camera for operation and or inactivating the camera, selecting the image from a camera(s) for use)), and
an image processing means (eg a computer and or image processor) preferably in part at least local to the storage means and or remote to the storage means (eg coupled by wireless and or wired connections (eg Internet/WAN/LAN),
it is preferable that part at least of the imaging system may be provided by a portable and preferably hand held electronic device/means (for example cellular phone, digital music/video player (eg MP3), digital camera, electronic key tag, means for controlling electrically operable garment closures);
an example of an imaging system preferably may include:
   a) electrically operable data processing means (eg microprocessor(s)/OSP/image processor) b) memory storage means, c) software and d) & database of information related to the objects for identification and ID means coupled to the object;

wherein

said imaging system, for example, preferably may be for use with a storage means comprising a plurality of storage locations, each location for storing a plurality of objects; and

wherein:

1) said imaging system for example, is preferably for acquiring/processing one at least images (preferably provided to the camera as visible/IR/UV light) from at least one;
I) objects/persons and or means coupled/attached to said objects/person) non-limiting examples of said image(s) preferably may comprise:
   a) image of the object/person that as non-limiting examples preferably may comprise one at least of:
      i) image (preferably colour) of a sock (preferably including one at least colours)/patterns/weave characteristics/shapes/ID means (eg colour coded means, barcode (preferably colour barcode) preferably for characterising the sock from one at least other socks and or garments and or other objects), II) bottle (eg characteristic shape/colour from one at least other bottles and or other objects), iii) chocolate (eg characteristic shape/colour/decoration from one at least other chocolates and or other objects), iv) beverage (eg characteristic colour/container from one at least other beverages and or other objects), v) food (eg, characteristic colour/texture/shape/container from one at least other foods and or other objects), vi) image of a person (preferably including characterising information for distinguishing the person from one at least other persons (for example, one at least of: hair colour/style, eye colour, skin colour, height, body build, facial information, clothing)) vii) location of a person (and or part of a person eg their eyes) relative to a storage location and or means for projecting light (eg laser));
   and or
   b) image on the object (eg printed onto a bottle and or container)/person (eg temporary tattoo and or stamped (eg using UV visible ink)) and or on a label (and or other means, eg badge attached to a person/ID means glued to the bottom of a bottle of wine and or attached to the neck of the bottle of wine) attached to the object, wherein non-limiting examples of said image preferably may include one at least of:
      i) photo-realistic image, ii) graphics, iii) drawing, iv) indicia, v) text, vi) barcode, vii) colour coded ID means (eg as disclosed in one of the PCT applications by the present inventors incorporated by way of reference into this specification, viii) Visidot colour coded ID means (preferably with integrated colour correction means) and or other object identifying means as disclosed at www.imaqeID.com and or as disclosed in patents/patent applications with imageID as assignee;

and or

II) storage location storing or for storing at least one object/person (for example to determine if the storage location is vacant or occupied) and or to identify the storage location (eg x and y coordinates, row/ column, seat row/seat number) from at least one other storage location (eg by imaging a plurality of storage locations and counting imaged storage locations up/down and or across (preferably from a known reference location) until the relevant location is counted), and or

III) location identification means (for example, one at least colour coded ID means (and or other means eg seat/row number, location number, coordinate means(eg x/y)) preferably with characteristic information compared to one at least other location identification means) attached/coupled to (preferably predetermined) positions on a storage means that includes a plurality of storage locations each storage location for storing one at least:
i) objects (eg a location in a a wine cellar for a bottle of wine and or a location on a shelf for an object (eg beverage container/container of food) and or parking space in a car park for a vehicle), and or
ii) persons (eg a seat for a person in a theatre/cinema/venue and or restaurant and or amusement ride),
wherein
said location information is preferably computer accessible (eg stored in a database in computer memory),

and

wherein:

2) said acquired/processed information is preferably for use by a computer for providing information facilitating determination of one at least of:
a) a location for storing the object/person,
b) a location storing the object/person,
c) a location of the object/person,
d) removal of the object/person from a location,
e) an operation on an object stored by a location,
f) positioning/adjusting the position (eg a motor to move a laser and or associated mirror) of a means for projecting light/facilitating projection of light.
g) if it is safe to project light (eg a laser beam, and said determination preferably includes using image capture/processing to determine if a person (preferably particularly their eye(s)) may be exposed to laser light,
h) identify position/address of a storage location (eg for determining the electronic address of an illuminable means associated with the storage location and or for directing projected light to the storage location (eg for selectively indicating the storage location)) that is part of a storage means comprising a plurality of storage locations and preferably one at least location identification means, wherein said identification includes imaging:
   one or more storage locations (preferably including the location for identification) and
   preferably one at least location identification means and said identification preferably includes processing of image information to determine the position of the location for identification relative to one at least reference (and or other) means (for example one at least storage locations (eg top left) and or one at least location identification means (eg seat number, location number)),
   for example, it is preferable that the computer may use image information:
      to count across/up/down storage locations and or location identification means from a preferably predetermined reference location to the location for identification,
         for example, it is preferable that a group of one or more locations may be delineated from other storage location by location identification means placed at one or more positions (eg each corner) of a preferably imaginary geometric shape (eg square/rectangle) bounding said group of storage locations,
It is preferable that identification of a storage location may be facilitated and or augmented and or replaced by other means (eg i) photo-emitter and photo-detector pair coupled to a storage location and or ii) RFID transponder attached to the object and or iii) one wire device attached to the object, said other means for example for detecting placement of an object/person at a storage location and or detecting removal of an object/person from a storage location),
j) identify occupancy status of a storage location (eg vacant or occupied);

and

said information provided for facilitating said determination is for example, preferably in response to a user (eg a person) input seeking a location of a stored object and or a location for storing an object, examples of said input preferably comprising: voice and or keyboard entry, and or touch screen entry, and or selection from a computer display (eg using a pointing means (eg computer mouse)to select from a menu and or one at least icons).
It is preferable that part at least of the input may me provided by a portable and preferably hand held electronic device/means (for example cellular phone, digital music/video player (eg MP3), digital camera, electronic key tag, means for controlling electrically operable garment closures).

The preferred means for providing the information for facilitating said determination preferably includes:
selectively illuminating the relevant locations), and or
a storage location for an object and or a storage location of an object preferably may be indicated by visual (eg text/graphics/images on a preferably multicolour (eg RGB) and or preferably multi-pixel (eg 640×400 pixels, 1024×720 pixels electronic display (eg colour LCD, OLEP/OLED display) and or audible (eg electronically generated voice on a speaker means), said visual/audible information for example descriptive information (eg co-ordinates) and or pictorial information (eg barcode, image of label on an object, image of colour id attached to the object/storage means) to assist locating said storage location/object).

The imaging system preferably includes a means for capturing/processing colour information related to an image, said colour information preferably comprising plural different colours (eg 8/16/24 bit colour information).

The imaging system preferably further comprises a means (eg a LED—preferably a white LED) for illuminating an object/storage location/location identification means, said illumination preferably for facilitating imaging of said object/location/location identification means. The illumination means for facilitating imaging is preferably computer controlled and preferably may be activated (in part at least) for imaging and inactivated (in part at least) when not imaging. It is preferable an illumination means for facilitating imaging may be coupled (eg attached) to: a camera (and preferably move with repositioning of the camera), and or a light projection means (eg laser/projector) and or other means (eg the storage means).

It is preferable that the imaging system is arranged for reading information from a plurality of objects/persons and or storage locations, said plural readings concurrent and or sequential and preferably under computer control and said readings preferably initiated/continued/terminated under computer control (compared to for example a person manually reading a barcode from an object—said reading initiated/continued/terminated by the person and said reading one barcode at a time).

It will be appreciated that means used (eg motors/mirrors/lenses) for directing a projected light to a particular storage location/object/person may be adapted for receiving light from said storage location/object/person for imaging said location/object/person by a camera.

It is preferable that for a first object/storage location that a first camera may be arranged for imaging an object/storage location from a first direction (for example: top/bottom/right/left/back/front) and a second camera may be arranged for imaging the object/storage location from a second direction distinct to the first direction.

It is preferable that a first camera may be arranged for imaging a first object/storage location and a second camera may be arranged for imaging a second object/storage location and preferable that the first camera may not be arranged for imaging at least part of the second object/storage location and preferable that the second camera may not be arranged for imaging at least part of the first object/storage location.

One at least cameras preferably may have its position changed (eg by a motor means) under computer control. One at least cameras preferably may have its focus changed (eg by a motor means) under computer control.

One at least cameras preferably may be caused (preferably under computer control) to have: a first position/focal length at a first time for receiving (preferably usable) images from an object i) as it is being placed in/ii) stored by/iii) removed from a first storage location and a second position/focal length distinct to the first position/focal length at a second time distinct to the first time for receiving (preferably usable) images from an object as ft is being placed in/stored by/removed from a second storage location wherein:
part at least of the image from the object at the second location is not received by the camera for said first position and or part at least of the image from the object at the first location is not received by the camera for said second position.

One at least cameras preferably may be causes (preferably under computer control) to have: a first position/focal length at a first time for receiving (preferably usable) images from a first part of an object: i) as it is being placed in/ii) stored by/iii) removed from a storage location and a second position/focal length distinct to the first position/focal length at a second time distinct to the first time for receiving (preferably usable) images from a second part of the object as it is being placed in/stored by/removed from the storage location wherein:
part at least of the image related to the first position/focal length is distinct to part at least of the image related to the second position/focal length.

One at least electronic, cameras preferably may be caused (preferably under computer control) to have: a first position/focal length at a first time for receiving (preferably usable) images from a first storage location and a second position/focal length distinct to the first position/focal length at a second time distinct to the first time for receiving (preferably usable) images from a second storage location wherein:
part at least of the image from the second location is not received by the camera for said first position and or part at least of the image from the first location is not received by the camera far said second position.

The imaging system preferably comprises at least one light beam redirecting means (eg: a mirror (and or other reflecting means)/prism/beam splitter) for directing an image (eg barcode, colour bar code, label) to a camera, said light beam redirecting means preferably movable (eg motor means) under computer control.

One at least said redirecting means preferably may be caused (preferably under computer control) to have: a first position at a first time for directing (preferably usable) images to a camera from an object as it is being placed in/stored by/removed from a first storage location and a second position distinct to the first position at a second time distinct to the first time for directing (preferably usable) images to the camera from an object as it is being placed in/stored by/removed from a second storage location wherein:
part at least of the image from the object at the second location is not directed to the camera for said first position and or part at least of the image from the object at the first location is not directed to the camera for said second position.

One at least said redirecting means preferably may be caused (preferably under computer control) to have: a first position at a first time for directing (preferably usable) images to a camera from a first part of an object as it is being placed in/stored by/removed from a first storage location and a second position distinct to the first position at a second time distinct to the first time for directing (preferably usable) images to the camera from a second part of the object as it is being placed in/stored by/removed from the storage location wherein:
part at least of the image related to the first position/focal length is distinct in part at least to the image related to the second position/focal length.

One at least said redirecting means preferably may be caused (preferably under computer control) to have: a first position at a first time for directing (preferably usable) images to a camera from a first storage location and a second position distinct to the first position at a second time distinct to the first time for directing (preferably usable) images to the camera from a second storage location wherein:
part at least of the image from the second location is not directed to the camera for said first position and or part at least of the image from the first location is not directed to the camera for said second position.

It is preferable that the object/person may be coupled to a visible ID means usable with the imaging system.
A non-limiting example of said visible ID means preferably comprises a colour coded ID (preferably comprising at least two colours). A preferred example of a colour coded ID includes Visidot as disclosed as www.imageID.com and or patents/patent applications assigned to imageID. Visidot includes colour bar code means and preferably an integrated colour calibration means.
A non-limiting example of said visible ID means preferably comprises one at least visible means disclosed at www.imageID.com and or patents/patent applications assigned to imageID.

It is preferable that the imaging system may be arranged for capturing/verifying/processing identifying information coupled to the object.

It is preferable that the imaging system is arranged for capturing identifying information from a plurality of objects/persons concurrently. It is preferable that the imaging system may image plural storage locations concurrently.

It is preferable that information related to an image from: an object/person and or coupled to an object/person and or a storage location may facilitate the selective illumination of:
the storage location for the object/person, and or
means proximal to the storage location for the object/person, and or
the object/person, and or
means proximal to the object/person;

from one at least other: storage locations for an object/person and or objects/persons (and or means proximal to said object(s)/person(s)).

For example said image related information preferably may be used for determining:
the identity of a storage location that an object has been placed at (and or removed from),
and or
information about an object placed at (and or removed from) a storage location, and
preferably providing this information to computer memory for storage (eg a database) wherein said stored information is preferably cross referenced with information for use in the subsequent selective indication of the object/person/storage location (for example said cross referenced information preferably may include the electronic address of an electrically illuminable means for selectively highlighting the storage location/object/person and or directions/coordinates for directing a projected light means (eg laser) at the storage location/object/person).

Non-limiting examples of said selective illumination preferably may include one at least of:
a) increased light intensity compared to at least one other storage location/object/person/means;
b) decreased (including OFF) light intensity compared to at least one other storage location/object/person/means;
c) one at least colours and or combination of colours (for example it is preferable that a red circle with an inner green circle projected onto a first storage location is selectively illuminated compared with a green circle with an inner red circle projected onto a second storage location) compared to one at least colours and or combination of colours associated with at least one other storage location/object/person/means;
d) variation (eg pulsing) in light intensity compared to one at least other storage location/object/person/means;
e) shape/text/graphics/image/indicia (eg projected onto the storage location/object/person) compared to at least one other storage location/object/person/means.

It is preferable that non-limiting examples of said selective illumination may be provided by one at least of:
a) an electrically illuminable means (eg one at least LED's, OLEP's, OLED's) coupled/attached to the storage location and or means proximal to the storage location and or the object/person and or means proximal to the object/person;
   For example, part at least of the illuminable means disclosed:
      in this specification (eg length means coupled to illumination means for use with a wine storage means), and or said PCT AU2005/000375 and or PCT AU2005/000256 (incorporated by way of reference) and or PCT AU2005/000242 (incorporated by way of reference) and or PCT AU2003/001029 (incorporated by way of reference);

It is preferable that a plurality of locations/objects/persons may be selectively illuminated concurrently (for example: i) a group of said plurality with a common feature and or ii) at least one of said plurality distinct to one at least others of said plurality) and one of said plurality preferably may be selectively illuminated with a first signal (eg first colour (eg red)) for a first person and another of said plurality preferably may be selectively illuminated with a second signal (eg a second colour (eg green)) for a second person said second signal preferably distinct to the first signal.
For example in a shop, two persons may each be looking for an object (eg a first and second bottle of wine) and the first person preferably looks for a signet of a first colour and the second person preferably seeks a signal of a second colour.

It is preferable that only one storage location/object/person may be selectively illuminated and it is preferable that said illumination may be a first signal (eg a first colour) if for a first person and preferably a second signal (eg a second colour) if for a second person, said second signal preferably distinct to the first signal. It is preferable that a storage location/object/person may be selectively illuminated with two signals concurrently wherein a first signal (eg first colour) is for a first person and the second signal (eg a second colour) is for a second person.
For example, this may be applicable if at least two persons are seeking the same object concurrently, and an example of the two concurrent signals preferably may include two laser beams illuminating the storage location/object/person wherein the first beam is preferably a first colour (eg red or green) and the second beam is a second colour preferably distinct to the first colour (eg green or blue).

For a plurality of concurrently selectively illuminated storage locations/objects/persons it is preferable that said selective illumination may provide a first signal (eg first colour (eg red) for at least a first storage location/object/person and a second signal (eg a second colour (eg green) for at least a second storage location/object/person).
For example, said first location/object/person may be associated with a first characteristic (eg the object may be a bottle of wine of a first type/vintage) and said second location/object/person may be associated with a second characteristic (eg the object may be a bottle of wine of a second type/vintage), said first and second characteristics preferably distinct from each other.

It is preferable that one at least means disclosed for said selective illumination (eg laser/projected light/proximal electrically illuminable means) of one at least storage locations may be used independently of and or may not use said electronic imaging and or processing means.
For example:
one at least objects preferably may be identified by known art RFID and or One Wire means prior to and or during placement at a storage location, and or while stored at a storage location, and or during removal and or after removal from a storage location;
and or
one at least objects preferably may not be coupled to a means for automatically identifying an object prior to and or during placement at a storage location and or while stored at a storage location and or during removal and or after removal from a storage location (for example a computer may store the location of an object and direct a laser to illuminate said object without being able to automatically read the id from a stored object).

It is preferable that image identification means of storage locations/objects disclosed in this specification as non-limiting examples may be used to replace/augment means disclosed (eg part at least of one at least: RFID transponder means. One Wire means, electro-mechanical abject detector means, photo-emitter and or photo-detector means) in said PCT applications incorporated by way of reference. Said image identification means preferably may use part at least of other means disclosed in said incorporated documents for relating storage location/object identifying information with other information (eg stored information and or incoming information).

The objects and storage means for use with the disclosed imaging system are preferably not limited. The objects and storage means for use with the light projection means as disclosed in this specification are preferably not limited. It is preferable that part at least of the means disclosed for one application/embodiment/example may be used with/for part at least of a means disclosed for another application/embodiment/example in this specification. For example, it is preferable that part at least of:
the disclosed imaging system and or light projection system already described in this specification and further disclosed with reference to the drawings, and or
the means disclosed in said incorporated PCT applications, and or
other means disclosed in this specification may be used with each other and or other means disclosed in the specification. It will also be appreciated that an example embodiment disclosed in detail, for example, a wine cellar preferably should be readily adapted for use with another example disclosed in less detail (for example a supermarket with items stored on one or more shelves may have information printed on a containers for an item, wherein the information is preferably functionally equivalent to that on (or subsequently attached to) a container of wine)

### PREFERRED EMBODIMENT OF THE INVENTION

The drawing are not necessarily to scale or proportion. It will be appreciated that production versions of parts shown for a wine cellar will preferably have dimensions typically for known art wine cellars. The thickness of the substrate means and or bonded conductors and or area OLEP/OLED illuminable means are preferably sub 1 mm. Known art polymer substrates are preferably sub 100 microns. Low profile surface mount LEDS/photo-emitters/photo-detectors/IC's are preferably attached to a length means comprised of: substrate (eg polymer) and bonded/attached electrical conductor. The length means is preferably selected from a width between 5 mm and less than 25 mm. It is preferable that illumination means (eg illuminable regions) distributed along the length means are preferably each of a length selected from 1 mm to 50 mm, and preferably a width selected from 1 mm to 20 mm. The conductors are preferably of widths typically used in the production of printed circuit boards and or flexible OLEP displays (eg those using add-vision technology). The barrier means are preferably of a thickness/width/length compatible with enclosing a length means while preferably minimising the size of the groove/furrow/channel (that may be collectively referenced as ‘channel’ in the description of the preferred embodiment) in the material of the wine storage means required to accommodate the barrier means. It is preferable that means discussed for use with a vertical member 3 may be used with other parts of the wine storage means (eg z-axis rails 2/x-axis horizontal members 1). It is preferably that depicted electrical conductor shown as a single line in any of the drawing and identified by a single identifier preferably may represent a plurality of separate conductors (eg a data bus/multiple control lines)

FIG. 1 of the drawings depicts an example storage means for wine comprising a front (5) (the part typically used for inserting/removing bottles of wine), a back (6), a plurality of approximately at least vertical (preferably structural) members (3), a plurality of approximately at least horizontal (preferably structural) members (1) in a direction approximately at least parallel with the plane of the front (5)/back (6) of the storage means (these horizontal members (1) may also be referenced as x-axis members), and a plurality of approximately at least horizontal (preferably structural) members (2) in a direction approximately at least at right angles to the plane of the front/back of the storage means (these horizontal members (2) may also be referenced as z-axis members). Part at least of a z-axis members preferably may provide supports for at least one bottle of wine (12).

It is preferable that the structural member are made of wood however it is preferable that part at least of one at least structural members may be constructed of any other suitable material (eg metal, plastic, glass).

FIG. 1 shows an open frame arrangement however the invention preferably allows that part at least of the storage means may be enclosed by one or more walls/partitions (for example panels 7 and or 8 and or 9, and or 10) and or other suitable means.

As as preferred objective of the invention is to highlight: a) an empty storage location as a place for placing a bottle of wine or b) as the location for retrieving a stored bottle of wine and or for performing an operation on the bottle of wine (for example rotating the bottle) it is preferable that the relevant location is readily identified as the target location when the appropriate illuminable means (for example) is illuminated. For a storage location (referenced as a closed location) enclosed in part at least (eg storage location 11 shown with panels enclosing the back sides top and bottom) an illuminated means within the storage location (eg attached to the back panel) would generally have most of the light confined to the closed storage location (apart from that expected to emerge from the front) by the panels, clearly selectively indicating that storage location. For an open storage locations (15) the light from an illumination means (13) for a particular storage location typically may leak across into other locations. It is preferable that for open storage locations (and preferably for closed locations) the light emits from a source attached proximal to the front of the storage location. Non-limiting examples preferably may include illumination means (14) attached to and or embedded within a vertical member on a surface facing into the storage location. It is preferable that each storage location may be illuminated from both sides (eg 14a/14b and or 14c/14d). It is preferable that the illumination means may be arranged for emitted light to be directed in part at least toward the front of the storage location and preferably in part at least onto the neck of a stored bottle (when present).

It is preferable that at least one illumination means 16, 16a, 16b may be attached to and or embedded within the front surface of one at least vertical members.

It is preferable that at least one illumination means 17 may be attached to and or embedded in at least one surface of at least one z-axis member.

It is preferable that at least one member (eg z-axis member) may be transparent and or translucent (eg plastic and or glass) in part at least and further preferable an illumination means is embedded within the member (eg z-axis member) said embedded illumination member arranged to emit light from the front and or along part at least of the length of said member. For example a) a strip of discrete LEDs, and or b) OLED/OLEP (eg strip of flexible material with OLEP patterned onto the flexible material), and or c) length electro-luminescent wire embedded along part at least of the length of a z-axis member.

It is preferable that at least one illumination means 18 may be attached to and or embedded in at least one surface of at least one x-axis member. A channel 30 is depicted running up/down a vertical member 3. Said groove 30 preferably may be arranged for receiving a length means or a barrier means (eg slid into the groove from the top of vertical member 3). Length means preferably may terminate in one at least control electronics 33a/53b preferably located at the top/bottom of the wine storage means. The termination preferably includes use of a connector means at the end of the length means arranged for coupling with a connector means attached to said control electronics 33a/33b. It is preferable that control electronics 33a/33b may be coupled by electrical conductors of a length means located in horizontal channel 34.

FIG. 2 depicts a non-limiting example of part of a wine storage means—in this example vertical structural member 3 is depicted with a channel 30a in one side of vertical member 30 and channel 30b in the opposing surface of vertical member 3. It is preferable that illuminable means on a length means located in channel 30a are for association with a first group of storage locations (said first group preferably comprising one at least storage locations, eg. storage locations using a rail 2 attached to the side of member 3 associated with groove 30a) and illuminable means on a length means located in channel 30b are for association with a second group of storage locations (said second group preferably comprising one at least storage locations—eg. storage locations using a rail 2a attached to the side of member 3 associated with groove 30b). It is preferable that the channel is arranged for an attached barrier means (not shown) of vertical member 3a and or length means (eg 20c) to be flush or below the surface of vertical member 3 and preferably allowing any z-axis horizontal member (eg rail 20) to be placed against the surface of vertical member 3 with length means 20c and or the associated barrier means covered in part by the rail 2. It is preferable that the channel 30 may be covered in part at least by one at least covers 31a/31b (that preferably match the material of the vertical member 3. Length means 20c is depicted with four illuminable regions 21e.1, 21e.2, 21e.3, 21e.4 (each preferably selectively illuminable independently of each other). Each said illuminable region preferably comprises one at least LED's (preferably bi-colour/tri-colour) and or area of OLEP means (preferably arranged for producing a plurality of colours). The length means 20/20c preferably slides into Channel 30a (or 30b) from channel end 19a (or 19b) and or the length means 20/20c preferably slides into a barrier means (not shown) located in channel 30a (or 30b) from channel end 19a (or 19b). Cross section A1 . . . A2 depicts length means 20a and 20b in channels 30a and 30b respectively of vertical member 3. Three alternative examples of length means 20 are shown in FIG. 2.
For example, illuminable region 21a, 21b, 21c, and 21d are preferably comprised of one or more LED's. Said LEDs preferably may be monocolour/bi-colour/tri-colour (eg for providing RCG colour combinations known to the art eg 8/16/24 bit colour). Each of illuminable region 21a, 21b, 21c, and 21d are preferably selectively illuminable/controllable. They are preferably powered/controlled by one or more electrical conductors (eg 22a/22b) that for at least one conductor preferably extend part at least of the length means.
As another example 23a, 23b, 23c comprise 3 illuminable regions (each preferably separately illuminable) of OLEP material preferably printed and or otherwise deposited onto the substrate (eg a polymer) of length means 20. Said OLEP material is preferably powered/control by electrical conductors 24a/24b (that are preferably metal tracks formed on the substrate of 20 and or conductive ink/polymer printed/deposited on said substrate). A control device 32 (eg microprocessor) is also shown coupled to the length means 20 and electrical conductors 24a/24b.
As another example 3 separate lengths of electroluminescent wire 25a/25b/25c are shown coupled to the substrate of length means 20 and powered by electrical conductor 26a/26b.
It is preferable that one at least illumination means may be provided by fibreoptic means that preferably run in a channels (eg 30a/30b) formed in the wine storage means. The fibreoptic means is preferably coupled to a substrate.

Vertical member 3a is shown with barrier means/length means 50a attached (eg glued/screwed) to the surface of member 3a.

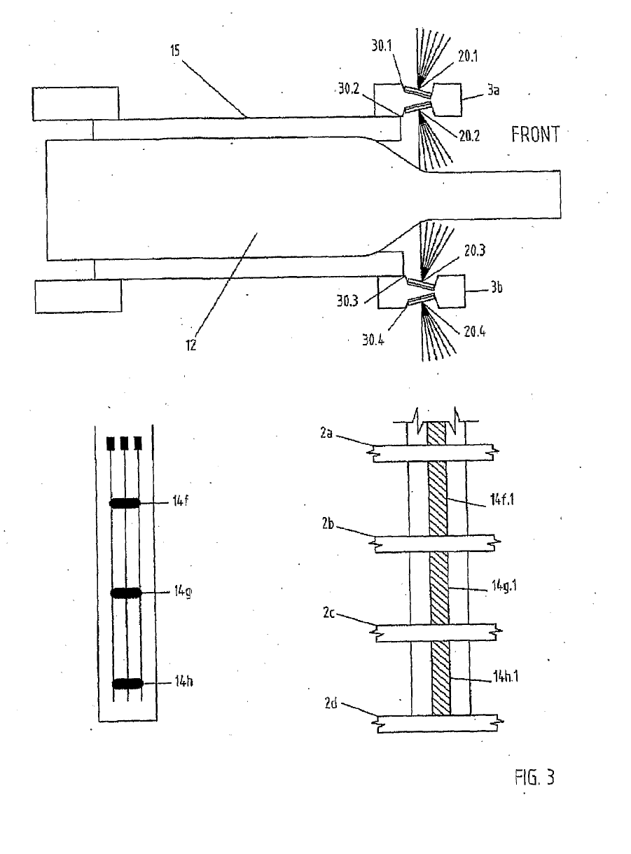

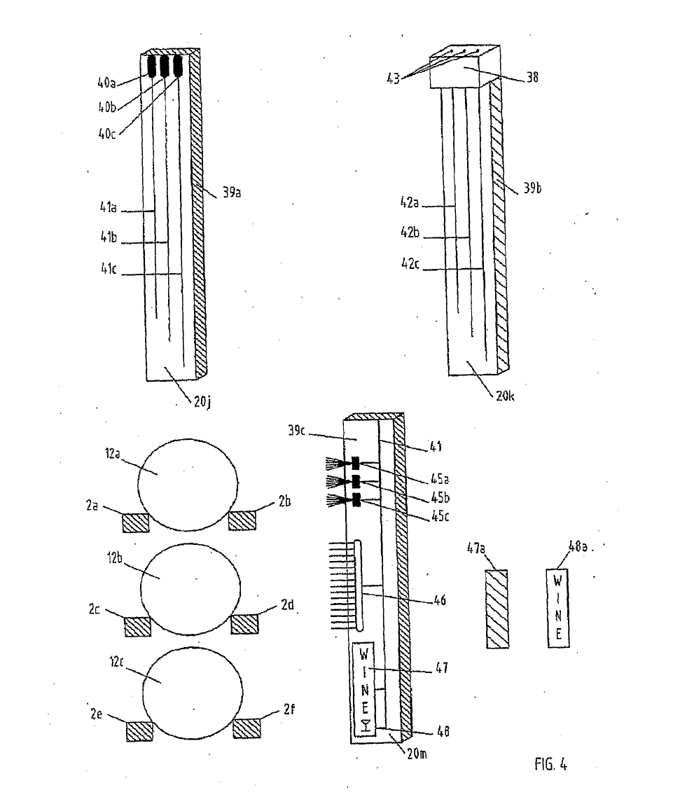

FIG. 3 of the drawings shows a wine storage container (eg bottle 12 ) located in a storage location 15. Cross sections through vertical member 3a and 3b show length means 20.1, 20.2, 20.3, and 20.4 located in channels 30.1, 30.2, 30.3 and 30.4 that are shaped to direct light from the length means 20.1, 20.2, 20.3, and 20.4 towards the front of the storage location rather than directly at the opposite side of the storage location. Illuminable means 14f, 14g, 14h, (eg a point source of light, eg a single LED) and/or illuminable areas 14f.1, 14g.1, 14h.1 (deposited OLEP material) are preferably spaced for: 14f/14f.1 to be proximal to a first storage location (eg defined by rail 2a above and 2b below) and or 14g/14g.1 to be proximal to a second storage location (eg defined by rail 2b above and 2c below) and or 14h/14h.1 to be proximal to a third storage location (eg defined by rail 2c above and 2d below).

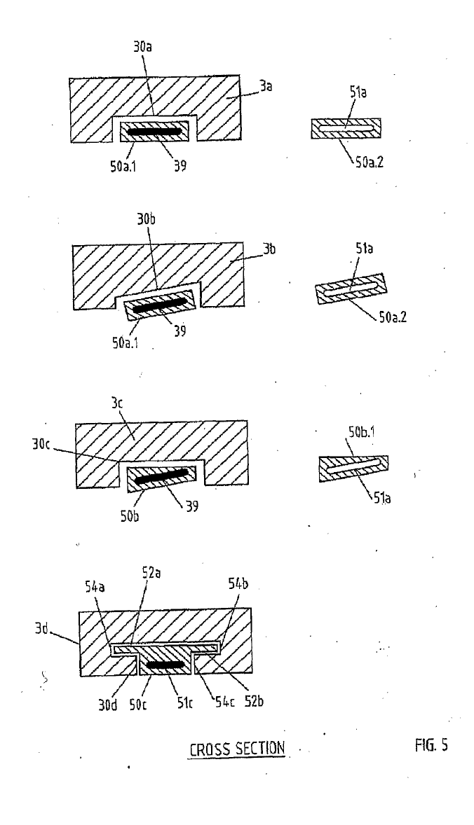

FIG. 4 shows length means 20j with electrical conductors 41a terminating in a conductive finger 40a, conductor 41b terminating in conducting finger 40b, and conductor 41c terminating in conductive finger 40c. The conductors are preferably formed on substrate (eg polymer) 39a. Fingers 40a/40b/40c preferably are examples of a connector means. They preferably may plug into a suitable receptacle (eg a connector means coupled to a second length means not shown). Length means 20k depicts electrical conductors 42a, 42b, 42c formed on substrate 39b terminating in connector means 38 (eg electronic socket/plug) preferably for coupling to another connector using conducting contacts 43. Length means 39c depicts examples of preferred arrangements for illuminable regions (eg region 1 comprising discrete LED's 45a, 45b and 45c and region 2 comprising area OLEP 46 and region 3 comprising area OLEP 47 that preferably may be printed onto the substrate 20m in the form of text (eg WINE 47) and or graphics (wine glass 48) and or an area of OLEP (47a) backlighting formed characters/symbols 48a (eg text/graphics formed from transparent parts surrounded by ink). An example of how a length means 39c may be positioned relatively to wine bottles 12a (resting on rails 2a and 2b), 12b (resting on rails 2c and 2d) and 12c (resting on rails 2e and 2f) is also shown. Illuminable region 45 is proximal to bottle 12a, region 46 is proximal to bottle 12b and region 47 is proximal to bottle 12c.

FIG. 5 depicts cross sections through example embodiments for a channel 30 in a vertical member 3.
The section through vertical member 3a shows a channel 30a essentially rectangular in shape. This accommodates barrier means 50a.1 that also shows length means 39 located within barrier means 50a.1. A cross section through barrier means of 50a.1 and identified as 50a.2 depicts the barrier means without the length means that is for insertion into void 51a. Void 51a preferably extends to and through at least one end of barrier means 50a.2 and preferably along part at least of the length of barrier means 50a.2.
The section through vertical member 3b depicts the same barrier means (50a.1 and 50a.2) and length means 39 with a channel 30b formed to angle the coupled barrier means 50a.1 (eg to direct light towards the front of a storage location.
The section through vertical member 3c depicts a rectangular channel 30c (eg similar to channel 30a of member 3a) and a barrier means 50b shaped to angle a coupled length means 39. The barrier means 50b.1 with void 51a is also depicted (without the coupled length means).
The section through vertical member 3d depicts another preferred arrangement for a channel 30d that is a main rectangular shape channel 54c with side channels (54a, 54b) for coupling with barrier means 50c that has flanges 52a and 52b for location within side channels 54a and 54b respectively. The flanges and side channels preferably arranged to assist at least the retention of the barrier means 50c in channel 30d. The void 51c for receiving a length means is also shown.

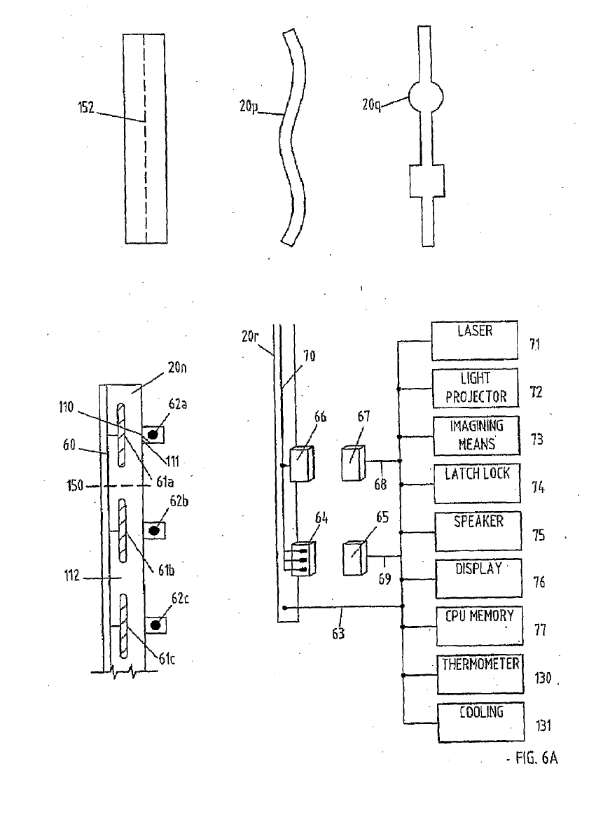

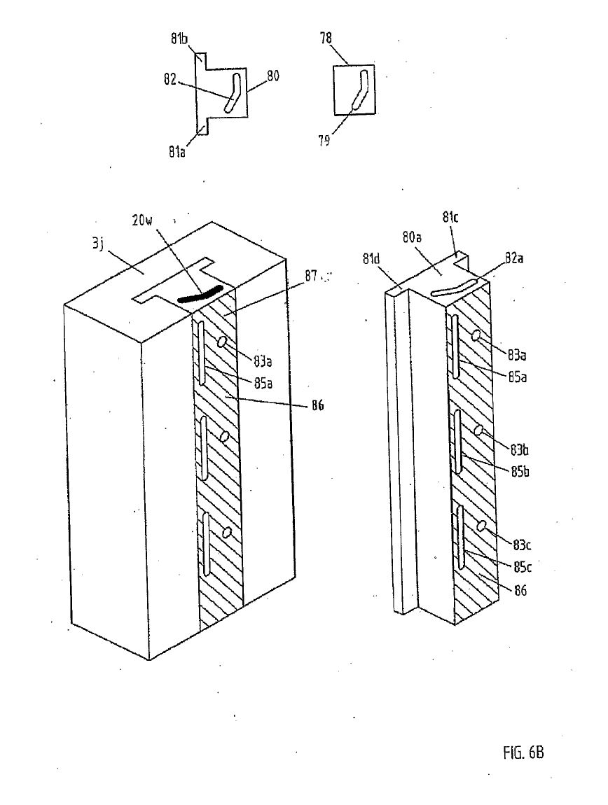

Referring to FIGS. 6a and 6b. It is preferable that a length means is not limited to a straight strip. For example length means 20p depicts a curved arrangement Length means 20q depicts variations in the width. Length means 20n depicts a length means (eg comprising a flexible polymer substrate) and illuminable regions 61, 61b and 61c deposited onto the substrate (eg using OLEP means). Photo-detector and or photo-emitter means 62a, 62b and 62c are also coupled to the substrate each arranged proximal to an associable illuminable region (eg 61a and 62a, 61b and 62b, 61c and 62c). The spacing of the illuminable regions and or photo-emitters/photo-detectors are preferably spaced to each be proximal to a related storage means when the length means is coupled to the wine storage means. The invention allows that the optimal direction for light from an illuminable means 61a may vary from the optimal direction of light from a photo-emitter (or the orientation of a photo-detector for optimal reception of light (preferably including visible and or IR and or UV light) 62a. One method preferably may include bending the length means along its long axis to accommodate two distinct directional means. As a preferred means of installing/removing a length means from a wine storage means is to insert/removed from a channel/barrier means at the top of vertical member 3 (FIG. 6b) the headroom between the top of the vertical member 3 and the ceiling (or other means) of the room used to located the wine storage means may be restricted. It may be necessary to bend/fold the length means at one or more locations along its length—eg bend/fold position 150 (eg along a short axis). For a length means with a fold along its long axis 152 the long axis fold may make a short axis fold 150 awkward. The preferred embodiment preferably allows for tabs 110 for use by a means 62a that may have their direction changed compared to the main plane 112 of the length means by bending/folding the tab along bend/fold line 111. This enables the length means 20n to be readily folded/bent at locations (eg 150) free of said tabs, the cross section through barrier means 78 depicts an associated void 79 arranged to accommodate a length means with a bend along its long axis (eg long fold 152 or tab folds 111). The cross section through barrier means 80 includes a similar void 82 as that for barrier means 78, however, barrier means 80 further comprises flanges 81a and 81b (the number of flanges preferably not limited) to assist holding the barrier means in place in the vertical member 3 (and or any other parts of the wine storage means). Barrier means 80a depicts a void 82a preferably extending the length of barrier means 80a, flanges 81c and 81d, an exposed face 89 of the barrier means 80a that is preferably arranged (eg screen printed imitation wood finish 84/veneer of real timber 84 glued and or otherwise coupled to the barrier means) to match or co-ordinate with the adjacent exposed surface of vertical member 3. The exposed face 86 of barrier means 86 preferably has transparent/translucent/absent areas (85a, 83a, 85b, 83b, 85c, 83c) to permit light to exit enter. Said transparent/translucent/absent area preferably overlay the the illuminable regions (eg 61a, 61b, and 61c) of a length means coupled to the barrier means. For example, for length means 20n inserted into barrier means 80a it is preferably that in part at least:
illuminable region 61a is located beneath transparent area 85a/photo-emitter means 62a is located beneath transparent area 83a; and or
illuminable region 61b is located beneath transparent area 85b/photo-emitter means 62b is located beneath transparent area 83b; and or
illuminable region 61c is located beneath transparent area 85c/photo-emitter means 62c is located beneath transparent area 83c.

Vertical member 3j is shown with a coupled barrier means 87 that is coupled to length means 20w.

The invention preferably allows that one or more components may couple to a length means. Said coupling preferably may be bonded to the length means (eg a connector/photo-detector/photo-emitter/LED/IC soldered/glued with conductive epoxy to an electrical conductor and or conducting pad means of the length means) and or applied directly to the substrate and or an electrical conductor of the length means (eg a an illuminable region of OLEP printed/screened onto the substrate/conductor. One at least of the components disclosed in the specification preferably may be bonded to the length means however it is preferable that one at least said components may be coupled (preferably reversibly) to the length means 20r using a connector means (eg conductive fingers 64 of the length means for mating with socket 65 attached to one at least components, socket 66 of the length means for mating with plug 67 attached to one at least components, conductor 63 for joining length means 20r and one at least conductors connected to one at least components). Said connected (preferably reversibly)components preferably may include one at least of: laser (71), light projector means (72). imaging means (eg CMOS camera means) (73), electrically operable latch/lock (74), speaker (75), display means (eg multicolour display comprised of a plurality of horizontal and vertical pixels) (76), CPU/Memory (77), electronic temperature sensing means (130), thermo-regulation means (eg cooling (eg Peltier)) (131). It is preferable that the coupling of a component to a length means may use one at least other length means.

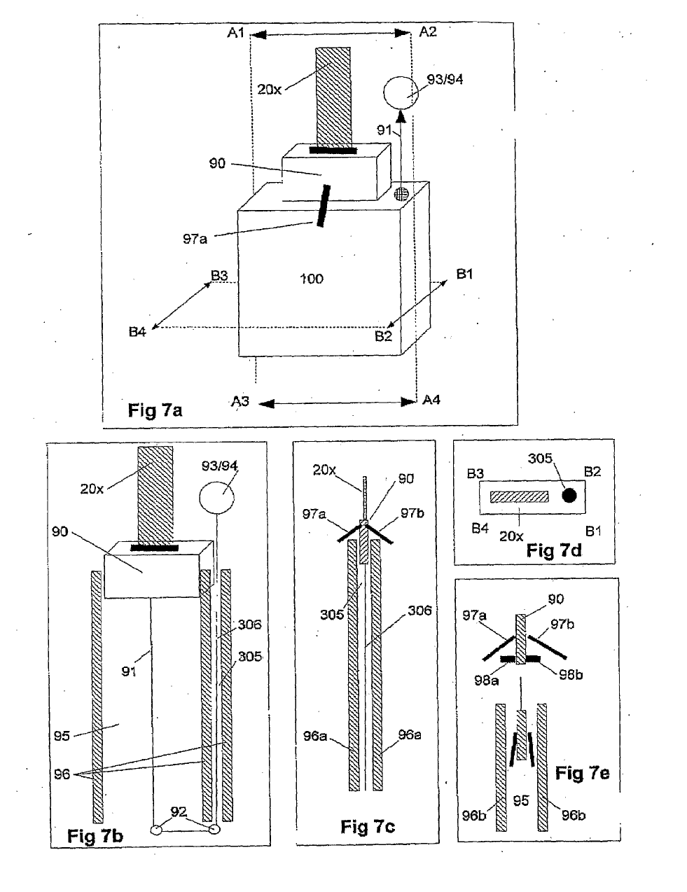

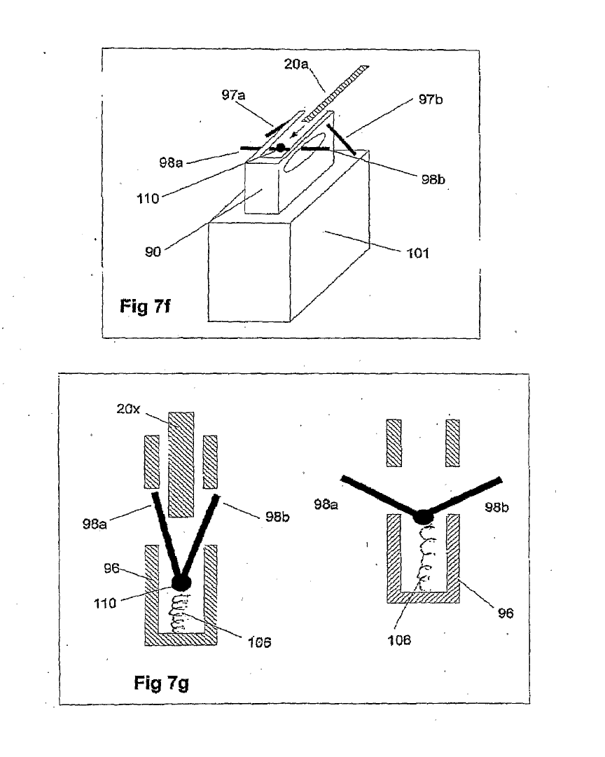

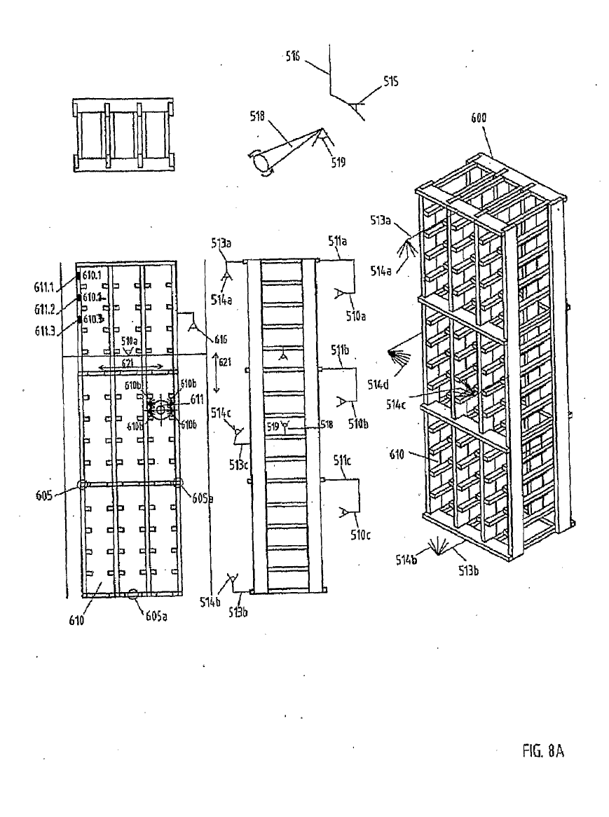

The invention preferably includes a puller means. FIG. 7a discloses an example of a puller means for facilitating coupling of a length means 20x to a barrier means (and or a wine storage means) and or for facilitating removal of a length means from a barrier means and or wine storage means. FIG. 7a depicts a barrier means 100 with a length means 20x attached to a earner means 90 (preferably part of the puller means) that is prevented from sliding down the void 95 of barrier means 100 by restraining means 97a. An example restraining means 97a preferably comprises a flexible protrusion means that moves (eg due to inherent elasticity/tension/compression) itself out over the end of the barrier means 100 when the carrier means 90 is moved sufficiently out of the void 95. The restraining means 97a preferably may be moved (eg pushed) into a position to let the carrier means 90 move back into the void 95, for example when wanting to insert the length means 20x into void 95. It is preferable that there is a means to pull the carrier means (and preferably a length means attached to the carrier means into the void 95).

FIG. 7b is a cross section in a plane A1 . . . A2 . . . A4 . . . A3 through the length and width of barrier means 100 and coupled means and FIG. 7c is a cross section at right angles to 104 through the length and depth of barrier means 100 and coupled means. FIG. 7d is a cross section formed by the plane B1 . . . B2 . . . B3 . . . B4 across the width and depth of barter means 100 and coupled means. It is preferable that a void 95 in barrier means 100 is arranged for carrier means 90 and an attached length means 20x to move inside the void from end 300 towards the opposite end 301 of barrier means 100. It is preferable that the inside of the barrier means may have plural voids (eg 95 for the carrier means and length means and 305 for a means (eg cable 306) to pull the earner. It is preferable that pulling handle 93 up moves cable 306 over wheels 92 (that preferably turn on an axle) pulling carrier means 90 down into the void 95. it is preferable that a motor means 94 maybe used to move cable 306.

It is preferable that carrier means 90 is prevented/restricted from moving into void 95 unless a length means is attached to the carrier means 90. For example, referring to FIG. 7e, guard means 98a/98b preferably project from the carrier means 90 and prevents/reduces retraction/movement of restraining means 97a/97b. It is preferable that attachment of a length means to carrier means 90 alters the position of guard means 98a/98b permitting restraining means 97a/97b to be moved to a position allowing earner means 90 (and the attached length means) to move into, void 95. FIG. 7f and 7g depicts an example earner means 90 with movable guard means 98a/98b arranged for pivoting at location 110. For example when length means 20x is slid into carrier means 90 it preferably pushes on the pivot location 110 compressing spring 106 and causing guard means 98a/98b to fold inside carrier means 90 improving mobility of restraining means 97a/97b. When length means 20x is removed from carrier means 90 the spring means 106 preferably pushes on pivot location 110 causing guard means 98a/98b to move into a position reducing mobility of restraining means 97a/97b.

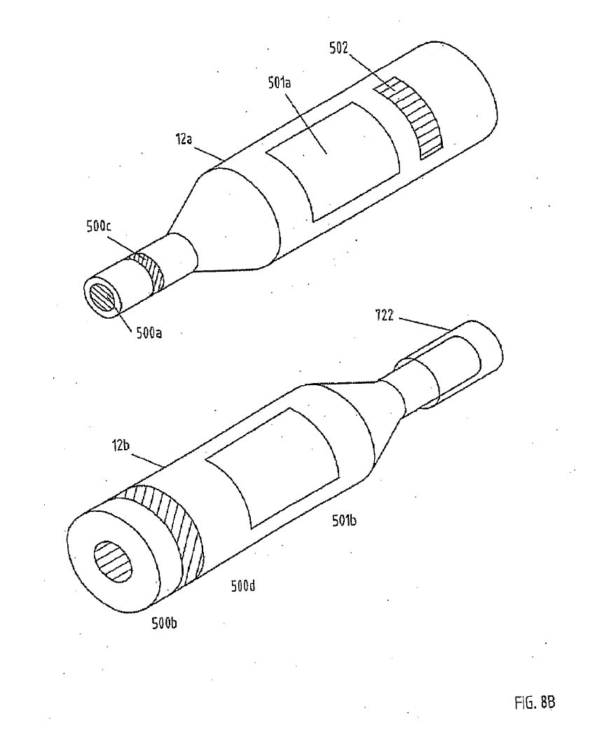

Wind Storage Means (eg Wine Cellar/Rack)—Refer to FIGS. 8a, 8b, 9a, 9b, 10, 11.

It is a non-limiting objective to describe an invention comprising:
I) An electrically operable means for use with a wine storage means FIG. 8a 600 (eg a wine cellar/wine rack), wherein:
   said wine storage means comprises a plurality of storage locations 610 (eg receptacles) each for storing at least one container of wine (eg bottles 12a/12b); and
said electrically operable means comprises:
   a computer far controlling the selective indication 611 of at least one storage location 610a (said indication-preferably by illumination of part at least of: the storage location, and or a container of wine at the storage location, and or means attached to the container of wine, and or means proximal to the storage location) from at least one other storage location (eg 610b) of said plurality; and
   computer accessible (eg by wired/wireless/WAN/LAN/internet means) memory storage means; and
   one at least of:
   a) part at least of a length means as disclosed in pages 1 through 8 of this specification and further described with reference to FIGS. 1 through 7 of the drawings;
   b) an electrically operable indicator (preferably an electrically illuminable means (eg LED/OLED/OLEP) 611 proximal to an associated storage location 610a and preferably a plurality of electrically operable indicator means each for coupling proximal to an associated storage location (for example indicator 611.1 coupled proximal to storage location 610.1, 611.2 coupled proximal to storage location 610.2, 611.3 coupled proximal to storage location 610.3);
   c) part at least of an imaging system (eg as disclosed in this specification), for example cameras: 510a/510b/510c/514a/514b/514c/514d/515/519/616 and image processing means (not shown);
   d) part at least of the light projection means (eg laser, projected image) preferably may be used for selectively illuminating one at least storage locations; and
   preferably: part at least of the means disclosed in said PCT AU2005/000375 “Automated Wine Cellar”

and or

II) A wine storage means coupled to part at least of the electrically operable means described for I);

III) A wine storage means for use and or particularly arranged for use with part at least of the electrically operable means described for I);

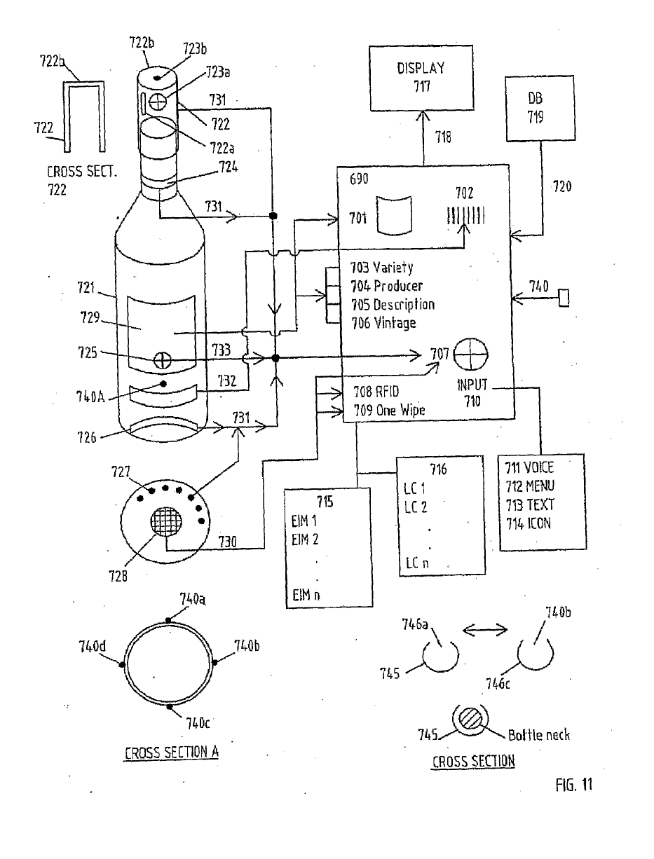

IV) Information stored in computer accessible media (eg one at least of: CD, DVD, hard disk, flash memory) and or provided by wired and or wireless and or fibreoptic means (eg one at least of WAN, LAN, internet) for use by part at least of the means described for I) and or II) and or III), example of said information preferably including information related to one at least containers of wine (for example information described later with reference to FIG. 11);

V) A container of wine coupled (eg attached, glued, printed onto) to an image ID and or an image ID for coupling to a container of wine, wherein said image ID is particularly arranged for use with the invention (eg RFID transponder/One Wire Device/Colour Coded ID means (eg Visidot) with a code particularly for use with the invention of I/II/III/IV);

VI) A container of wine coupled to an image ID and or an image ID for coupling to a container of wine wherein said image ID comprises one at least of: bar code, colour coded means (eg Visidot), shape means (eg as described at imageID.com), said ID means preferably for use with the invention I/II/III/IV/V and said ID means preferably further arranged as one at least of:
a) a sleeve means 722 of FIGS. 8b and 11 for coupling to a bottle of wine (for example FIG. 8b, 12b and or FIG. 11, 721) wherein the sleeve means preferably may have one at least openings (722a) in the sleeve and an opening at one end of the the sleeve for receiving the top and preferably part at least of the neck of the bottle, and said sleeve preferably closed 722b in part at least at the opposite end, and the sleeve preferably further arranged to exert a force (eg friction) against the neck/top to facilitate keeping it in place (for example the sleeve is preferably comprised in part of elastic material that stretches as the sleeve is applied to the bottle, said sleeve preferably held in place by the tensile force of the stretched material) and the ID 723a is preferably coupled to the external surface of the sleeve 722 (said 723a is preferably replicated for at least one other location around the sleeve and or at least one image ID distinct to said 723a is located at one at least other locations around the sleeve and or the ID 723b is preferably coupled the closed in part end 722b;
b) it is preferable that an image ID can be viewed independently of rotation of the bottle (eg label (or other reference means) up or down or left or right) when inserted to/stored by/removed from a location:
b.1) for example it is preferable that a plurality of cameras may be arranged for viewing a container of wine from different angles,
b.2) for example it is preferable that a plurality of image ID's may be coupled to a container (eg bottle) of wine, wherein at least a first image ID is preferably at/for a first location of the container (eg label area) and a second image ID is preferably at/for a second location (eg opposite the first image ID) and said plurality of image ID's are preferably sufficient to have an image ID for a container of wine determined by at least one camera regardless of said rotation, said image ID's preferably circumferentially distributed around the container (for example cross section ‘A’ through bottle 721 of FIG. 11, showing image ID's 740a, 740b, 740c, and 740d);
c) image ID provided on a band 724 around part at least of the neck of a bottle of wine 712, said band preferably extending the circumference of the neck and the ends of the band preferably may be joined, wherein it is further preferable the band forming a ring is in part at least elastic for enabling it to stretch as it is placed on the neck of the bottle, or the band preferably includes an opening between the ends (for example the band may be: i) adhesive (preferably readily removable (eg using 3M Post it Notes type adhesive) and stick to the neck and or ii) a formed flexible material (eg plastic) 745 that attaches to the bottle by increasing the width of the opening (746a to 746b) (eg by pushing it against the neck of the bottle) enabling the band to surround part of the neck allowing the arms to come together in part at least 746c) (eg from stored tensile force from said increased width) and or iii) printed onto the neck of the bottle, and or
the image ID is preferably provided on a band 726 similar to band 724 however for use around the body of the bottle (eg near the base of the bottle);
d) ID 728 (eg RFID Transponder, One Wire means, image ID) coupled to the bottom of a bottle (or other container) of wine for example as disclosed in PCT AU2005/000375;
e) image ID 727 on the bottom of a bottle (or other container) of wine (preferably around part at least of the bottom); said image preferably printed onto the bottle, preferably Using ink/paint that may be readily removed (eg rubbed off/wiped off).

It is preferable that at least one image ID may be printed onto one at least of: known art label on a bottle and or known art barcode label (preferably with or without the barcode)

Although coupling of an image ID means is described in detail for a container of wine it will be appreciated that the means preferably may be applied to (and or modified for) other objects. Bottles of beverage (eg ingredients for an alcoholic cocktail) other that wine preferably may be coupled to an image ID means using the same/similar/equivalent means to those disclosed for a container of wine. It is preferable that at least one image ID means may be printed onto a box/packet for example. It is preferable that one at least image ID means may be produced on a label (eg self adhesive) for sticking to an object (eg a bottle or a packet/box for storage on a store (eg supermarket) shelf).

FIG. 8a depicts a plurality of preferred example camera, arrangements, one at least cameras preferably able to be repositioned (eg motor means under computer control) and preferably coupled to a means (eg LED, OLED) for illuminating part at least of an image ID and preferably coupled to a light projecting means (eg attached to same extension means), wherein it is preferable the camera and light projection means may share a common motor mean, said cameras preferably comprising one at least of:

1) Cameras 514a, 514b, 514c, 514d preferably on extension/support means 513a, 513b, 513c, 513d respectively, wherein the cameras are preferably arranged for imaging information on the walls/side/neck of a container (eg bottle) of wine, typically as containers are inserted/removed to/from a storage location,
non-limiting examples of said information preferably including i) a label (eg FIG. 8a 501a, 501b; FIG. 11 729 (that preferably may include for example one at least of: type of wine, vintage, producer, information about the wine and or producer, image ID 725 (eg bar code/colour coded ID (eg an image ID)) and or ii) barcode 502 (eg on a label and or printed onto the container) and or iii) an image ID (eg 731/724/726/740a),

wherein:

a) camera 514a is preferably located at the top front (preferably on extension means 513a) for looking down on one at least wine containers inserted to/removed from a location (eg 610) via the front of the wine storage means 600, and or

b) camera 514b is preferably located at the bottom front (preferably on extension means 513b) for looking up at one at least wine containers inserted to/removed from a location (eg 610) via the front of the wine storage means 600, and or

c) camera 514c is preferably located at the left side (viewed from the front) (preferably on extension means 513c) for looking at the left side of least one wine container inserted to/removed from a location (eg 610) via the front of the wine storage means 600, and or

d) camera 514d is preferably located at the right side (viewed from the front) (preferably on extension means 513d) for looking at the left side of least one wine container inserted to/removed from a location (eg 610) via the front of the wine storage means 600,

wherein

one of the cameras preferably may capture an image ID in whole or part and for a part capture it is preferable that one at least other cameras capture the other parts of the image ID (the computer preferably combining image information obtained from plural cameras); and or

2) Camera 515 (eg coupled to a ceiling by extension means 516) arranged to view part at least of the front of the wine storage means and preferably an image ID 723b on the top of stored wine bottle (eg stored approximately horizontal); and or

3) Cameras 510a/510b/510c (coupled to extension means 511a, 551b, 511c) attached for viewing the back of the wine storage means and preferably at least one image ID (500b/728/727) attached/coupled to the bottom of a container of wine; and or

4) Camera 510x arranged for moving across a preferably horizontal means 621 (eg as known for x-y plotters) and or up/down preferably vertical means 620 (eg as known for x-y plotters), said 510x preferably located at the back of the wine storage means; and or

5) camera 519 preferably on extension means 518 arranged for rotation (eg using computer controlled motor)—said rotation preferably for permitting the camera 519 to view the lower side (for a bottle laying horizontal) of a first bottle in a first rotated position and the upper side (for a bottle laying horizontal) of a second bottle (eg a bottle immediately beneath the first bottle) in a second rotated position distinct to the first rotated position, it is preferable the the camera 519 may be arranged for moving in and out of a receptacle means and preferable that the camera may be coupled to an x-y means as disclosed for camera 510x to enable it to move up/down and or across a plurality of receptacles.

A typical container of wine comprises information applied to the container (eg printed) and or on one at least labels attached (eg glued/adhesive) to the container, said applied information preferably on the container prior to shipment from the producer/distributor of the container of wine. The applied information preferably may include for example one at least of: a printed ID means (eg a barcode), producer name, variety of wine, vintage, information about the wine/producer, country/region of production, graphics, photo-realistic image.

FIG. 11 depicts information 690 stored in computer accessible memory (eg as a database), said information 690 preferably comprising information related to a plurality of different wines each distinguished from the other by one at least of the following example means:
label information 701 (eg text/graphics/image), bottle shape/size, barcode 702 on a container of wine, variety of wine 703, producer 704, description related to the wine 705, vintage 706, image ID 707, RFID code 708 (eg binary code stored by a transponder attached to a container of wine). One Wire Code 709 (eg binary code stored by a one wire device attached to a container of wine), digital voice information reference 711 related to a container of wine for comparison with incoming voice digitised (eg via microphone 740) and compared to the digital voice reference 711, information from a menu 712 on an electronic display, text information 713 for comparison with incoming text (eg from a keyboard means/menu selection), icon means 714 for comparison icon selected from an electronic display, information associated with an electrically illuminable means 715 (eg binary code x preferably may=the address of electrically illuminable means EIM1 associable with a storage location for a first bottle and binary code x+1 preferably may=the address of electrically illuminable means EIM2 associable with a storage location for a second bottle), information associated with a projected light means (eg stored information LC1 preferably may=co-ordinates for directing a projected light means (eg laser beam) to a first storage location/wine container and stored information LC2 preferably may—co-ordinates for directing a projected light means (eg laser beam) to a second storage location/wine container.

It is preferable that subsequent to input information related to a container of wine (eg from voice input/menu input/text input/icon input) said input information may be compared with stored information 690 to determine the relevant containers) of wine and information related to the relevant container of wine output (eg on display means 717 (eg text/image/graphics), and or activating one at feast electrically illuminable means (eg EIM1), and or directing projected light to one at least storage locations (eg LC1)).

For example, it is preferable that part at least of information 690/input related (eg 711/712/713/714)/address information 715/co-ordinate information 716 may be programmed into the memory from an external source (eg from stored information in a database 719 stored on optical disc (eg CD/DVD) and or means coupled by LAN/WAN/Internet).

It is preferable that part at least of information 690 may be obtained from a container of wine—for example a camera preferably may read barcode 502 and or image ID (724/725/726/727/723a) and or RFID Code (726)/One Wire Code (728) and couple part at least of this information together (eg in memory), and or couple part at least of said information read by a camera from the container with other information imaged from the container/container label (eg producer, vintage, wine type) and or couple part at least of the information obtainable from a bottle with previously stored information 690 (eg previously obtained from a container and or external library 719).

It is preferable that the RFID/One Wire means disclosed in PCT AU2005/000375 for tracking insertion/removal/identification of one at least containers of wine may be replaced/augmented in part at least by an imaging system as disclosed in this specification.

It is preferable that the imaging system may be used to replace/augment non-imaging means for detecting (eg electromechanical switch or photo-emitter and photo-detector pair means) the presence at/absence from a storage location of a container of wine. For example one at least cameras and image processing preferably may be able to track container insertion/removal and preferably identify the associated storage location. It is preferable that at least one storage location for a container of wine may be coupled to a photo emitter/detector pair (eg IR emitter and IR detector) and or other non-imaging means for detecting placement/removal of a container of wine to/from a storage location wherein information related to said non-imaging detection means preferably may be processed in conjunction with the imaged information and or to augment/facilitate use of said imaged information.
For example, the imaging system preferably may capture an image of a container of wine being inserted/removed to from a storage location and correlate this with information from said non-imaging detector means (eg for confirmation and or because an object/person may be obscuring imaging in part at least).
In another example the non-imaging detector means preferably may be used to trigger the imaging system to image part at least of the storage means (preferably a part including the storage location associated with the non-limiting detector), for example, to determine identifying information related to the container of wine causing activation of the non-imaging detector means.

It is preferable that part at (east of the means disclosed in this specification and further described with reference to drawings 1 through 7 may be used to implement part at least of the means disclosed in said PCT AU2005/000375 and or the presently disclosed imaging system.
For example said length means preferably may provide for part at least of:
   the means for attaching electrically operable means to storage locations for providing the selective indication of said 000375, and or
   means for providing power/control/data to/from cameras/image processing means of the presently disclosed imaging system, and or
   means for providing power/control/data to from the projected light means.

The light projection means of the present specification preferably may replace and or augment part at least of the electrically illuminable devices coupled to a wine storage means as disclosed in said PCT AU2005/00375 and or the present disclosure.

It is preferable that part at least of the means for the imaging system and light projection means may be combined and or otherwise used to facilitate each other. For example, a laser that is arranged to project a beam to a storage location preferably may be attached to a camera that typically would be expected to sharing a similar path to the storage location (albeit in opposite directions (eg light from the storage location to the camera)). It is preferable that motor means for repositioning the laser and or and or light redirecting means (eg a mirror) for redirecting the laser beam preferably may be shared in part at least with the camera means.
For example the laser motor means preferably may also be arranged to position the camera at another object/storage location and or at a different part of an object.
For example a light redirecting means preferably may change the storage location/object and or part of the object imaged by a camera.

It is preferable that an imaging means (eg part at least of the disclosed imaging system) and or non-imaging means (eg photo-detector mean, pressure pad means) may used to detect the presence of a person in the vicinity of a wine storage means (eg wine cedar), said detection preferably may activate part at least of electrically operable means (eg a camera, voice output/input) associated with the wine storage means.

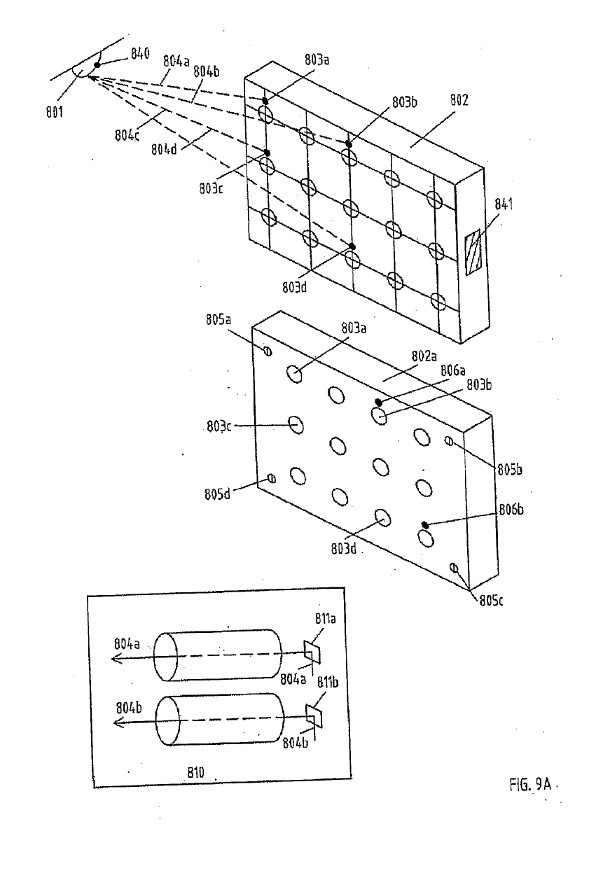

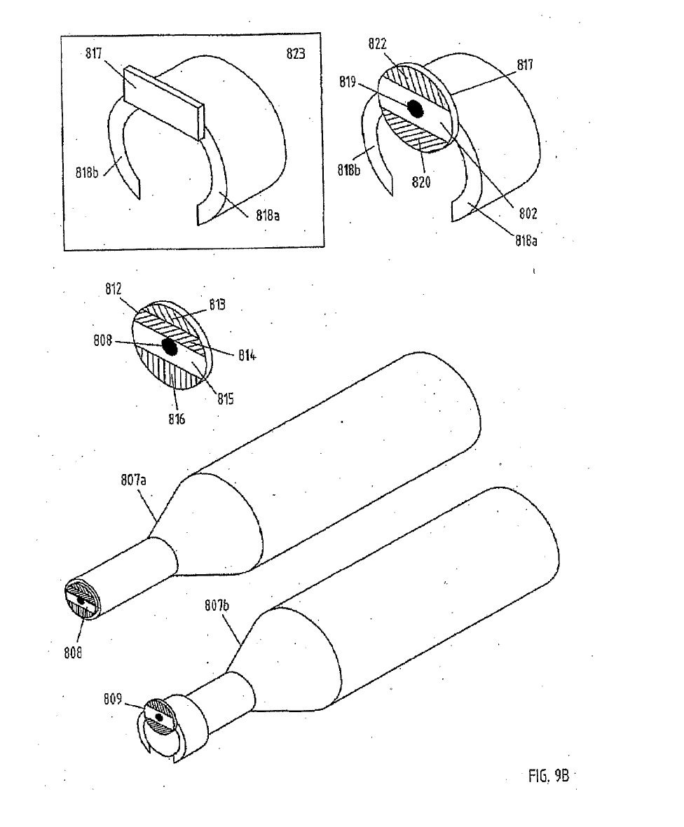

FIG. 9a discloses an example means for selectively identifying wine containers and or storage locations for at least one container of wine using projection light, for example, projected light from a light projection means (eg laser, spotlight, projector (eg Microvision “Pico Projector”) 801 (preferably coupled to a camera means 840) is preferably arranged for selectively illuminating one at least wine containers/wine container storage locations (preferably concurrently and or sequentially), for example; laser beam 804a for illuminating part at least of storage location 803a and or laser beam 804b for illuminating part at least of storage location 803b, and or laser beam 804c for illuminating part at least of storage location 803c and or laser beam 804d for selectively illuminating part at least of storage location 803c). It is preferable that part at least of a container of wine stored at one at least of the preceding storage locations 803a/803b/803c/803d may be illuminated by the associated laser beam instead of or together with the associated storage location. It preferable that two at least of the depicted laser beams (eg 804a/804b/804c/804d) are from the same laser and preferably redirected (eg computer controlled motor means adjusting the position of the laser and or reflecting means (eg a mirror—preferably movable by a computer controlled motor means). A control means (eg computer) 841 is shown. It is preferable that reference means (805a/805b/805c/805d) may facilitate the directing of light from one at (east light projection means. It is preferable that camera means 840 may image the position of a laser beam relative to one at least reference means (eg 805a) and pass this information to a computer preferably for use in readjusting the projected path of light (eg 804a) if applicable.

Block drawing 810 depicts another example for a light projection means wherein laser beam 804a preferably may be reflected by mirror 811b (preferably driven by a computer controlled motor) into a storage location for viewing from the front of the storage location and laser beam 804a (that preferably may be the same as laser beam 804b) preferably may be reflected by mirror 811a (preferably driven by a computer controlled motor) into a storage location for viewing from the front of the storage location.

FIG. 9b depicts an example of an image ID, Object 812 shows a plurality of different coloured areas (813, 814, 808, 815, 816). An example means for attaching an image ID (819) is depicted using flexible arms 818 and 818b that slip over (preferably) opposing parts of the neck of a bottle of wine.

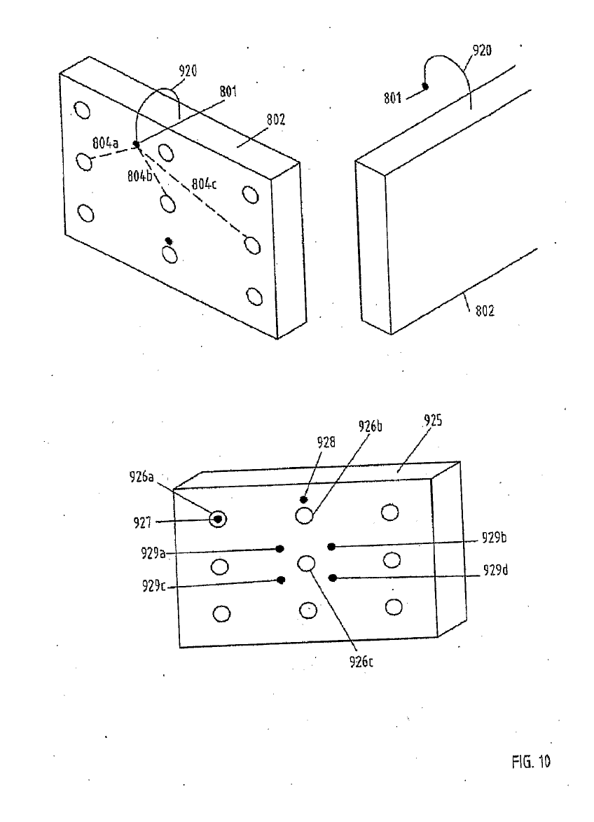

FIG. 10 depicts an example embodiment for coupling light projection means to a wine storage means 802 is shown, with extension means 920 preferably folding light projection means 801 in position for projecting laser beams 804a, 804b and or 804c at associated storage locations. Example means for selectively indicating a storage location preferably may include one at least of: a) projecting light 927 into a storage location, b) projecting light 928 to a location proximal to a storage location, c) projecting light (929a, 929b, 929c and 929d) to plural locations proximal to a storage location.

One at least images of a person storing/removing a container of wine (and or other objects) preferably may be stored (eg for future reference (eg security purposes)).

It is preferable that one at least objects for selective illumination by a projected light means may have a means for further directing received light, preferably as multiple beams of light (eg a prism means that redirects a beam of light into multiple beams of tight emerging from the prism means, and or a fibreoptic means to redirect received light into one at least different directions, and or transparent/translucent/reflecting means with plural facets).

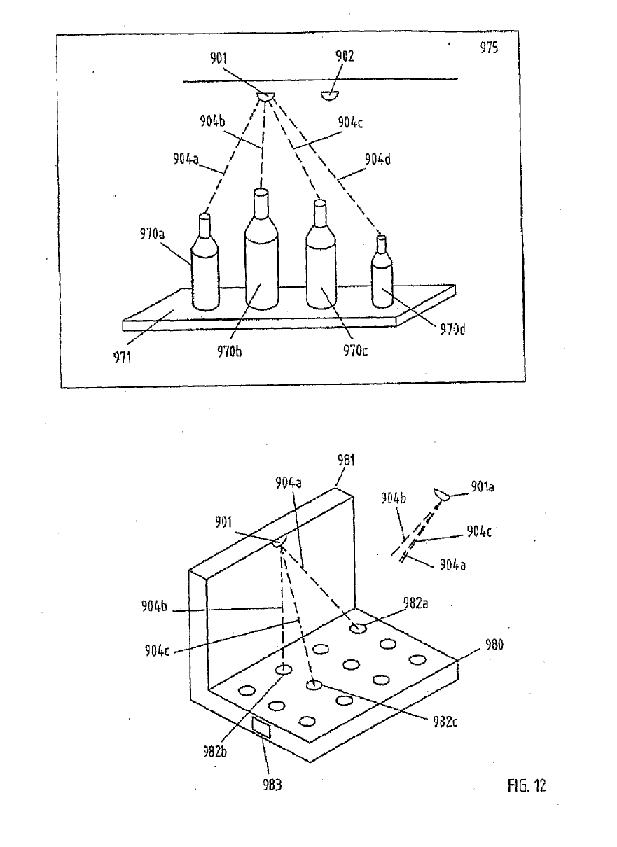

It is preferable that the means disclosed for a light projection means and further disclosed for use with a wine storage means may be used (and or readily adapted) in part at least for use in selectively indicating other objects, said objects preferably not limited. For example, referring to FIG. 12, block drawing 975 shows a plurality of containers (eg bottles) of beverage 970a, 970b, 970c, 970d (for example alcoholic beverage (eg ingredients for one at least alcoholic cocktails) stored on a shelf (as a non-limiting storage means) that preferably may be selectively illuminated by at least one projection means 901 (eg laser) selectively indicating: container 970a with laser beam 904a a first time, and preferably container 970b with laser beam 904b at a second time preferably distinct to the first time, and preferably container 970c with laser beam 804c at a third time preferably distinct to the first and or second time time, and preferably container 970d with laser beam 904d at a fourth time preferably distinct to the first and or second and or third time. It is preferable that one at least of laser beams 904a, 904b, 904c and or 904c may originate from the same projection means (eg laser diode) said beams preferably distinguished by repositioning the laser and or repositioning redirecting means (eg mirrors). It is preferable that one at least beams may originate form a different light source to one at least other of said beams. It is preferable that one at least cameras 902 may be used for detecting the position of projected light relative to an object (eg for redirecting the beam if appropriate) and or for determining image ID information attached to one at least containers.

FIG. 12 depicts a storage means 980 for objects showing projected light means 901 attached to the storage means for selectively illuminating one at least storage locations (982a, 982b and or 982c) sand or projected light means 901a (eg attached to the ceiling) for selectively illuminating one at least storage locations.

The storage means for objects preferably may include as non-limiting examples: storage means (eg rack/racks, shelf/shelves, table top, floor (eg storing items of furniture in a store), ceiling (eg light fixtures for sale hanging from a ceiling in a store), cocktail cabinet) fan containers of beverage items (eg alcoholic beverage(s) (eg mixers for alcoholic cocktails)/non-alcoholic beverage(s) (eg fruit juice, flavoured milk, milk, soft drinks)) and or food items in containers and or bulk (eg cans food, packets cereals, pack of sugar) and or supermarket items (eg cleaning items, toiletries, detergents) and or means for receiving socks during sorting/matching (eg table top); and or storage means (eg cabinet/wallboard/drawer) for lock keys; and or storage means (eg herb/spice rack) for storing containers of and or bulk (eg heap/pile) herbs/spices; and or container (eg box) for/of: chocolates and or candy; and or storage means for containers of ingredients ((eg alcoholic ingredients for a cocktail/chemicals/cooking recipe ingredients) and or bulk storage (eg heap of sugar on a shelf)) for use in preparing a mixture (eg alcoholic cocktail/non-alcoholic mixed drink/mixture of chemicals) from a plurality of ingredients.

The electronic imaging and or image processing means preferably may be used for identifying one or more objects in a room, said object(s) preferably for selective highlighting by a light projection means (eg laser/projector).

It is preferable that the means disclosed for a stored beverage container may be used for a plurality of containers of food and or beverage.
For example it is preferable that a plurality of containers each for storing one at least herbs/spices may be stored by a storage means (eg a herb/spice rack) and in response to user input (eg voice command/selection from a menu on an electronic display/selection using a touch screen means/key board input) for a particular herb/spice the relevant container/storage location is preferably illuminated (eg a) by an electrically illuminable means proximal to the container/storage location and or by projected light means, and or otherwise indicated (eg by computer controlled motor moving a requested herb/spice container to a preferably predetermined position). It is preferable that an image ID may be coupled to one at least of said herb/spice containers for identification by one at least cameras. It is preferable that RFID/One wire means maybe used for identifying one at least containers of herbs/spices. It is preferable that part at least of the means disclosed in said PCT AU2005/000375 maybe used/adapted for use with a means for storing a plurality of containers for herbs/spices. Preferred examples of a herb/spice rack preferably ma include a rack/shelf and or carousel means (eg that turns by computer controlled motor (eg to indicate the requested container of herbs/spice).

It is preferable that part at least of the projected light means and or the imaging system may be used for facilitating preparation of a mixture comprising a plurality of ingredients. The type of mixture is preferably not limited (for example it preferably may be a mixture of different chemicals) however it is preferable that the mixture comprises a mixture of food (eg sugar/butter/margarine/plain flour/self raising flour/herbs/spices/chocolate/cornflour/cooking recipe ingredients/rice/pasta (preferably including subtypes of pasta)/ginger/garlic), and or beverages (eg one at least: alcoholic beverages/milk/wine/fruit juice/flavours/ingredient for alcoholic cocktail). It is further preferable that one at least ingredients (preferably in a container and or stored in bulk (eg a pile on a shelf) is stored by a storage means (eg shelf) for a plurality of other objects (for example ingredients for said mixture and or ingredients for one at least other mixtures). It is further preferable the projected light means is arranged for selectively illuminating at least one of: a) said ingredients/b) ingredient container/c) storage location for the ingredient (and or ingredient container) and or d) means proximal to the storage location. Said selective illumination may preferably be for indicating the ingredient/ingredient container from one at least other of said plurality of objects. Said selective illumination is preferably a response to computer processing of ingredient information stored in computer accessible memory storage means and preferably indicates that the selected ingredient is the next ingredient for addition to the mixture (said ingredient preferably may be the first ingredient of the mixture). It is preferable that a plurality of ingredients for a mixture may be sequentially and or concurrently selectively indicated (it is preferable that the order of selection may or may not reflect the order that they are for addition to the mixture. A preferred mixture is an alcoholic cocktail and or a mixed beverage (eg milkshake (milk+flavouring+ice cream).

It is preferable that one at least objects for use in preparing a mixture is coupled/attached to one at least image ID means, and or RFID transponder, and or One Wire Means.

It is preferable that part at least of the imaging system may be used for identifying one at least chocolates and or other items of confectionery in a storage means (eg a box of chocolates). Said imaging means preferably may facilitate determination of the position of one at least chocolates/other items of confectionery at said storage means. It is preferable that in response to an input (eg from a person describing a required chocolate (eg milk chocolate with cherry cream centre) to a computer that said computer may use information from the imaging system for facilitating: a) activation (eg illumination) of an electrically illuminable means attached/coupled to the required chocolate/confectionery item and or means proximal to said chocolate/confectionery item and or b) for facilitating (eg providing co-ordinate information) a light projection means to project light for illuminating (preferably selectively) said chocolate/confectionery item and or means proximal to said chocolate/confectionery item.

It is preferable that the light projection means may be used for selectively illuminating a chocolate/confectionery item and or means proximal to said chocolate/confectionery item without said imaging system (eg said chocolate/confectionery item preferably may be identified and or the position at the storage means determined by for example: a) RFID transponder/One Wire device attached/coupled to the chocolate/confectionery item and or b) information stored (eg previously stored) in computer memory relating to the identification/position of a chocolate/confectionery item)

It is preferable that part at least of the disclosed imaging system for identifying objects may be used for identifying an object (eg container of alcoholic mixer drink) for use in preparing a mixture. It is preferable that part at least of the means for preparing a mixture of beverage/food as disclosed in said PCT AU2005/000375 may be used in the preparation of mixtures of the present specification. It is preferable that part at least of the means for selectively indicating an ingredient as disclosed in said PCT AU2005/000375 may be replaced and or augmented by the presently disclosed light projection means. It is preferable that the means for identifying one at least ingredients for a mixture as disclosed in said PCT AU2005/000375 may be replaced/augmented by the image ID means/imaging means disclosed in the present specification. It is preferable that the projected light means may be arranged for producing a plurality of colours that, preferably may be used to provide the means described for in said PCT AU2005/000375 for colour coded means (eg a first colour for a first person and a second colour for a second person, and or a first colour for a first type of object and a second colour for a second type of object, and or a first colour for a first operation (eg removal of an object) and a second colour for a second operation (eg placement of an object).

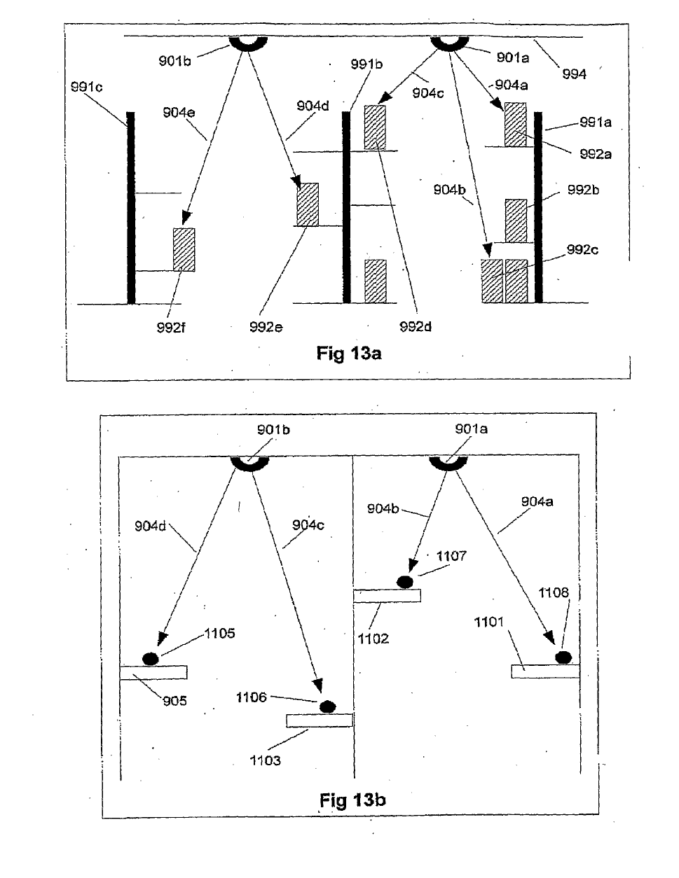

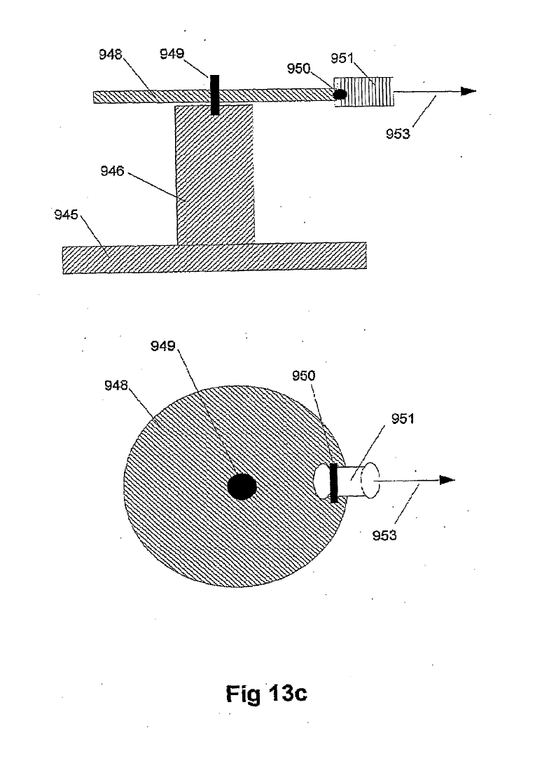

FIG. 13a depicts a preferred arrangement for selectively illuminating a storage location 991b/object (eg 992a, 992b, 992c, 992f) on one at least storage means (eg shelves) for example in store (eg supermarket, bottle shop) using one at least light projection means (eg 901a, 901b (for example attached to ceiling 994) arranged for projecting light at one at least storage locations/objects. It is preferable that one at least objects (eg 904e, 904a) stored in a store (eg supermarket) may be coupled to an image ID means preferably for identification in part at least by an imaging system as disclosed in this specification. For example said image ID preferably may comprise a colour code barcode (eg Visidot) and or information/graphics printed on an object (eg container of food/beverage/soap powder/toilet paper).

FIG. 13b depicts a plurality of objects in one at least rooms (eg watch 1105 on bench 905 (room 1), mobile phone 1106 at storage location 1103 (room 1), keys 1107 location 1102 (in room 2), wallet 1108 location 1101 (room 2). Light projection means 901b is shown for selectively identifying objects 1105 and or 1106. Light projection means 901a is shown for selectively identifying objects 1107 and or 1108. Example means for identifying an object for providing locating information for the light projection means preferably may include one at least of:
a) disclosed imaging system/means for imaging visible objects (eg determine object from image of the object and or an image ID means attached to the object) and determining their location from surrounding means and or coupling GPS (or equivalent co-ordinate determining means) to an object (eg a means coupled to an object sends location information by wireless to a computer that positions a laser beam to illuminate part, at least of the object and or means proximal to the object and or b) RFID transponder and or c) one wire means.

FIG. 13c, shows an example light projection means comprising base 945, support 946, turntable means 948 preferably arranged for turning (eg preferably using computer controlled motor (and or other force means eg shape memory alloy, solenoid)) around pivot point 949, said turntable preferably for adjusting projection means 951 (eg laser/projector/spotlight) in a horizontal plane and pivot means 950 for adjusting the vertical position of projection means 951, said vertical adjustment preferably by a computer controlled motor means (and or other force means eg shape memory alloy, solenoid). Side views and top views are shown. It is preferable that the direction of the projected light 953 (eg laser beam) may be determined by adjusting the horizontal (eg around 949) and or vertical (eg around 950) position of the projecting means 951.

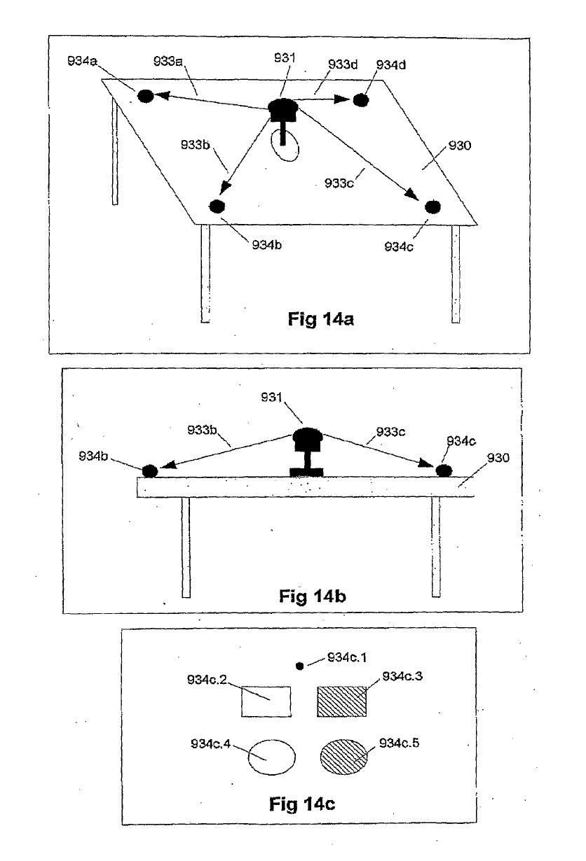

A system for sorting matching socks into mating pairs and or garments into matching sets (eg set 1=garments for a first person and set 2=garments for a second person) is now described with reference to FIGS. 14a, 14b, & 14c of the drawings. The part at least of the means disclosed in PCT AU2005/000256 “Electronic sock sorting and mating system” by the present inventors (incorporated by reference) preferably may be used with part at least of the means of the present disclosure. Part at least of the means of the present disclosure preferably may be used with part at least of said 256. Said 256 discloses a means for selectively activating (eg illuminating) an electrically illuminable means for indicating a position to place a sock. The sock sorting system preferably comprises a plurality of electrically illuminable means each for a sock and or a pair of matching socks. It is preferable that part at least of the electrically illuminable means may be replaced/augmented by a light projection means. For example, it is preferable that in response to identifying information (eg coupled image ID means) being read from a sock/garment to a computer that the light projecting means may be positioned to project light at a location for placing the sock/garment. It is preferably that matching members of a set (eg two members of a pair of socks) may be placed at the same location and or adjacent locations. For example it is preferable that for identifying information read from a first sock a light projection means 931 may project light 933d at storage location 934d for placing said first sock and for identifying information read from a second sock the projection means 931 may project light 933b to location 934b for placing the second sock (said first and second sock preferably not a matching pair) and for identifying information read from a third sock the projection means 931 may project light 933d to location 934d for placing the third sock (said first and third sock preferably a matching pair). The storage means for socks in this example is a table top 930. The light projecting means is preferably a portable device. It is preferable that a camera (not shown) may be used for facilitating positioning of the projected light. Example means of identifying a sock preferably may include one at least of RFID transponder attached to the sock and or one wire device attached to the sock and or image ID attached/printed/coupled to the sock. It is preferable the projected light may form a point source 934c.1 and or outline a shape (eg pattern 934c.2/934c.4) and or a filled shape (eg 934c.3/934c.5). It is preferable that projected light may be used to provide other information (eg write the name of the owner of a sock/garment).

It is preferably that part at least of the disclosed imaging system/image ID means may be used for identifying one at least socks. The location to place a sock preferably indicated by a projected light and or by an electrically illuminable means. It is preferable that means used for pairing socks may be used for sorting a plurality of garments (eg from a basket of washing) into sets (eg person 1's clothing and person 2's clothing).

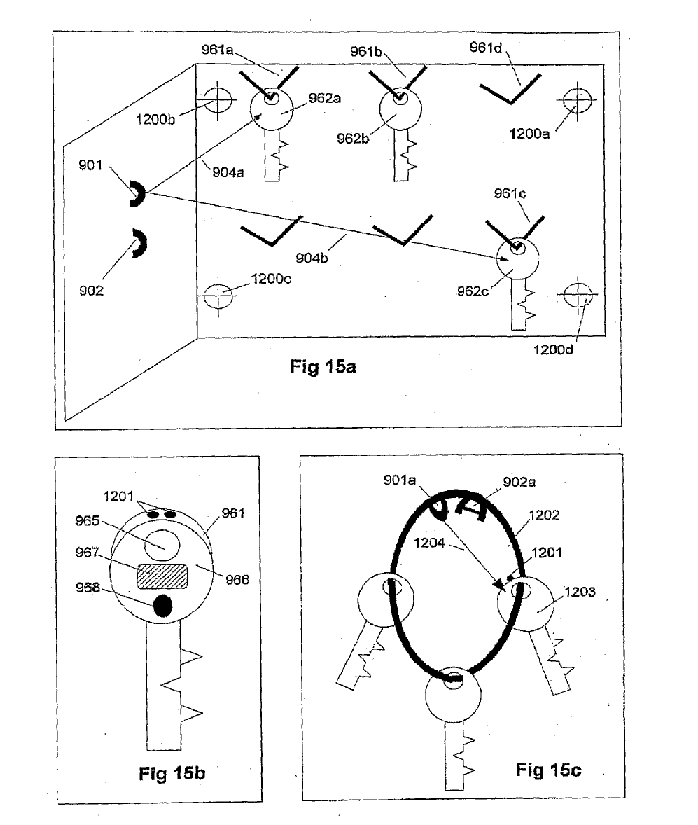

The known art discloses storage means for a plurality of lock keys (preferably mechanical keys and or electronic keys and or electro-mechanical keys). The known art key storage means typically include a plurality of locations each for attaching a key or a group of keys (eg coupled together by a key ring). A hook means is one method for coupling a key(s) to a key storage means (eg a wallboard/cabinet). Known art key storage means disclose locked cabinets for storing keys. The key storage means preferably may be a portable means (eg a key ring). The know art discloses means for attaching a key to the storage means that prevent the key being removed unless authorised (eg enter a code into a computer coupled to the key storage means). The known art also disclose means for a computer to determine the identity of one at least keys attached/coupled to a key storage means and preferably the location of the key. Typical means for identifying a key (or group of keys) include the coupling of an RFID transponder and or One Wire means and or other electrically operable device to a key and or group of keys. It is preferable that part at least of the imaging system disclosed in this specification may be used to identify one at least lock keys (and or groups of lock keys) and preferably identify the position of said key(s) at the storage means. For example, FIG. 15a shows a key storage means 960 with storage locations 961a, 961b, 961c, 961d each for storing one at least keys (eg key 962a at location 961a, key 962b at location 961b and key 962c at location 961c (as shown, location 861d is not presently coupled to a key). It is preferable that camera 902 may image one at least of the stored keys and computer processing of the imaged information preferably facilitates identification of one at least keys. It is preferably that one at least location means (eg 1200a, 1200b, 1200c, and or 1200d) may be imaged by the camera and used to facilitate identifying the location a key(s) is/are stored at (eg which hook, (eg 961a) and or the position of a key relative to one at least other keys. It is preferable that a camera (eg 902) may be used to facilitate directing a projected light at a key (and or means proximal to the key). For example it is preferable that a camera (eg 902) may image the position of projected light (eg a laser beam) relative to a key and or means proximal to a key, said image information for use by a computer for determining if the projected light is correctly positioned and if not, said computer preferably providing information to the light projecting means to reposition the projected light (preferably with further confirmation/calibration from the imaging system (eg camera 902) appropriately.

It is preferable that one at least said keys are coupled (eg attached to a hole in the key and or fabricated onto the key (eg onto key handle)) to a (preferably image ID) ID means (eg one at least coloured shapes/indicia and or colour barcode (eg Visidot)). For example, referring to FIG. 15b, key 961 includes hole 965, first colour shape 966, second colour shape 967 and third colour shape 966. Said first/second/third coloured shapes preferably may be the same colour and or distinct colours.

Referring to FIG. 15c it is preferable that one at least keys has an image ID or similar on the handle edge 1201 (eg for imaging by a camera 902a (eg part of a key fob) attached to a key ring 1202 attached/for attachment to the key 1201, said key preferably selectively illuminated by projected light 1204 (eg laser beam) from light projection means 901a (eg semiconductor laser) that preferably may be positioned under computer control.

It is preferable that the the ID coupled to a key is distinct to one at least other keys. It is preferable that an ID for a key is associated with information related to the lock that the key operates (for example as disclosed in PCT AU2003/001029 “Identification and selection of keys for use with locks” by the present inventors) said information preferably stored in computer accessible memory storage means.

It is preferable that information related to a lock operated by the key may be provided to a computer: coupled to the imaging system and preferably coupled to a means for providing information about the key. Example means for providing information to the computer preferably comprise one at least of: a) voice input, b) touch screen means, c) keyboard, d) selection of a menu on a display means, (eg LCD/OLED multi-pixel display (eg 640/400 pixels)) e) icon on a display means, f) reading an ID means coupled to the lock (eg image ID/RFID transponder/One Wire device).

It is preferable that part at least of the computer may be local to the key storage means (eg in a key fob coupled to a key ring and or in a portable electronic device (eg cell phone)) and or remote (eg coupled by Internet/WAN/LAN).

It is preferable that part at least of the means for providing information related to a lock to a computer may be provided by a portable electronic means (eg electronic key fob/cellular telephone).

It is preferable that in response to the computer receiving input related to a lock that the computer may provide information to facilitate the selective indication of the key associated with the lock. For example said computer preferably facilitates: a) activation of an electrically illuminable means (eg by accessing an address coupled to the illumination means) attached to the key and or means proximal to the key and or b) provides information to a light projection means for projecting light (eg laser beam) at the key and or means proximal to the key.

It is preferable that one at least known art electrically illuminable means for indicating a key(s) from a plurality of stored keys may be replaced by the disclosed light projection system for selectively illuminating part at least of an object (eg key) and or means proximal to the object from one at least other objects/means-proximal to the other objects). It is preferable that the light projection means may be used in conjunction with the imaging system for identifying a key and or the position of a key at a storage means. It is preferable that the light projection means may be used in conjunction with known art means (eg RFID transponder/One Wire means) for identifying a keys and or the position of a key at a storage means. FIG. 15a shows light projection means 901 selectively illuminating key 961a with projected light 904a and key 962c with projected light 904b (said projected light preferably may be concurrent or non-concurrent).

It is preferable that part at least of the means disclosed in PCT AU2003/001029 and PCT AU2005/000242 (both incorporated by way of reference) may be used with the key storage means (and or other means) of the present disclosure and or part at least of the means of the present disclosure preferably may be used with part at least of the means of said 1029 and or 242.

It is preferable that the disclosed imaging system may be used with a computer to determine the location of a vehicle in a car park (eg by recognising the car colour/make/model/registration number/ID means attached to the vehicle) said information for use in selectively illuminating (eg electrically illuminable means and or projected light means) the vehicle and or means proximal to the vehicle, said illumination preferably a response to a request to locate the vehicle. It is preferable that the projected light means may be used for selectively illuminating the vehicle and or means proximal to the vehicle, said illumination preferably in response to a request to locate the vehicle. Example means for requesting location of a vehicle preferably include inputting information into a portable electronic device (eg cellular/mobile telephone, key tag) said information preferably comprising one at least oft name of owner, registration number, vehicle colour, vehicle make/model.

It is preferable that part at least of the disclosed light projection means may be used for directing a person to a seat (or other means) at an entertainment venue (eg cinema, theatre, stadium, sporting event) and or other venue (eg political rally, visit by the Pope). It is preferable that part at least of the disclosed imaging system may be used to facilitate directing a person to a seat (or other means) at an entertainment venue (eg cinema, theatre, stadium)—for example by recognising the person (eg. face recognition, clothing, image ID (eg on their ticket and or means attached to their clothing) and preferably associating said imaged information with a seat (for example) and preferably for providing this information for use in determining which seat to selectively illuminate (and or otherwise indicate)—said selective illumination preferably by: a) an electrically illuminable means attached to the seat and or proximal to the seat and or b) a projected light (eg laser beam).

The invention preferably allows for an object and or image ID means particularly arranged for use with part at least of the means of the present invention, non-limiting examples of said particularly arranged preferably include at least one of:
a) a lock key (and or ID means for use with a lock key) with characteristic shape(s)/colour(s)/indicia/RFID Transponder code/One Wire means code for use with part at least of the: i_ disclosed imaging system and or ii) light projection means and or iii) key selection means of the present disclosure;
b) a sock (and or ID means for use with a sock) with characteristic shape(s)/colour(s)/indicia/RFID Transponder code/One Wire means code for use with part at least of the: i) disclosed imaging system and or ii) light projection means and or iii) sock mating and or garment mating means of the present disclosure;
c) a wine container (and or ID means for use with a wine container) with characteristic shape(s)/colour(s)/indicia/RFID Transponder code/One Wire means code for use with part at least of the: i) disclosed imaging system and or ii) light projection means and or iii) wine storage means of the present disclosure;
d) a beverage container (and or ID means for use with a beverage container) with characteristic shape(s)/colour(s)/indicia/RFID Transponder code/One Wire means code for use with part at least of the: i) disclosed imaging system and or ii) light projection means and or iii) means for preparing a mixture of the present disclosure;
e) a herb/spice container (and or ID means for use with a herb/spice container) with characteristic shape(s)/colour(s)/indicia/RFID Transponder code/One Wire means code for use with part at least of the: i) disclosed imaging system and or ii) light projection means and or iii) herb/spice storage means of the present disclosure;
f) an image ID means (eg colour barcode (eg Visidot)) for use with part at least of the disclosed imaging system for use in directing a person to their seat at an entertainment venue (and or other venue).

It is preferable that a first colour signal (eg from electrically illuminable means and or from a light projection means) may be for association with a first person/object/means (eg. as disclosed in this specification) and a second colour signal (eg from electrically illuminable means and or from a light projection means) may be for association with a second person/object/means (eg. as disclosed in this specification). Said first and second signals preferably may be concurrent or non-concurrent. Said first and second colours are preferably distinct to each other. Said first and or second signals preferably may be comprised of a plurality of colours.
For example:
   a) a seat at a venue selectively illuminated by a red laser beam may be for a first person and a seat at the venue selectively illuminated by a green laser beam may be for a second person;
   b) a pair of socks highlighted in a first colour may be for a first person and a pair of socks highlighted in a second colour may be for a second person;
   c) a key on a storage means illuminated with a first colour may be for a first person and a key on a storage means illuminated with a second colour may be for a second person;
   d) a first object (eg beverage container/food item) on a shop shelf (and or other storage means) selectively illuminated with a first colour may be for a first person and a second object (eg beverage container/food item) on a shop shelf (and or other storage means)selectively illuminated with a second colour may be for a second person;
   e) a first object (eg container of alcoholic beverage) may be for a first mixture (eg alcoholic cocktail) and a second object (eg container of alcoholic beverage) may be for a second mixture (eg alcoholic cocktail);
   f) a vehicle selectively illuminated by a first colour signal preferably may be for a first person and a vehicle illuminated by a second colour preferably may be for a second person.

The description and examples of this specification are by way of example only and not intended to be limiting. Other embodiments will be obvious to those experienced in the art.

1-95. (canceled)

96. A system for storing plural bottles of wine comprising:
a) a structure defining a plurality of contiguous storage locations, each storage location for at least one bottle of wine; and
b) an ID reader for reading identifying information from at least one of the stored bottles at a first instant and from at least one other stored bottle at a second instant; and
c) a machine controlled mechanism for moving part at least of the ID reader from a region proximal to the bottle for the reading of the first instant to a region proximal to the bottle for the reading at the second instant; and
d) a computer arranged for receiving one at least of:
i) said read identifying information,
ii) information derived from said read information.

97. The system for storing plural bottles of wine of claim 96 wherein the identifying information comprises one at least of:
a) a bar code,
b) an image,
c) text,
d) a shape,
e) a color,
attached to the stored bottle.

98. The system for storing plural bottles of wine of claim 96 further comprising a machine controlled mechanism for cleaning part at least of the identifying information of a bottle of wine while the bottle is at said storage location.

99. The system for storing plural bottles of wine of claim 98 wherein said machine control includes a computer for controlling re-positioning of the cleaning mechanism from proximal to a first of the stored bottles to proximal to a second of the stored bottles.

100. The system for storing plural bottles of wine of claim 96 wherein part at least of the ID reader is for machine controlled positioning in the void between stored bottles of wine.

101. The system for storing plural bottles of wine of claim 100 wherein part at least of the ID reader is for machine controlled re-positioning from a void between at least two stored bottles of wine to a void between at least two different stored bottles of wine.

102. The system for storing plural bottles of wine of claim 100 wherein the ID reader is for one at least of:
a) positioning from a location external to a void between at least two stored bottles of wine to a location between at least two stored bottles of wine,
b) positioning from a location between at least two stored bottles of wine to a location external to a void between at least two stored bottles of wine.

103. The system for storing plural bottles of wine of claim 97 further arranged for the machine controlled reading of said identifying information from bottles located at said storage locations.

104. The system for storing plural bottles of wine of claim 103 wherein the identifying information is on the sides of the bottle for identification.

105. The system for storing plural bottles of wine of claim 97 wherein the reading of the identifying information facilitates the computer association of at least one of:
a) said identifying information,
b) information derived from said identifying information, with a particular said storage location.

106. The system for storing plural bottles of wine of claim 105 wherein the association with a particular storage location facilitates the computer controlled selective highlighting of said storage location in response to a user input related to one at least of:
a) vintage,
b) type,
c) producer,
of the wine in the bottle at said storage location.

107. The system for storing plural bottles of wine of claim 96 further comprising a means to detect one at least of:
a) the proximity of a person to the system;
b) the placement of a bottle of wine to a storage location;
c) removal of a stored bottle of wine from a storage location.

108. The system for storing plural bottles of wine of claim 107 further comprising a digital camera for facilitating said detection.

109. The system for storing plural bottles of wine of claim 107 wherein said detection facilitates initiating the machine controlled reading of identifying information from a bottle at one at least said storage locations.

110. The system for storing plural bottles of wine of claim 96 wherein the computer is further arranged for receiving information from a digital camera.

111. The system for storing plural bottles of wine of claim 110 wherein the information from the digital camera is for facilitating one at least of:
a) the machine controlled positioning of a projected light,
b) computer determination of the position of a person with respect to projected light,
c) computer determination of the position of a person with respect to an intended projected light,
d) computer determination of the position of a person with respect to at least one of the storage locations,
e) computer determination of the safety of projecting light at a particular time,
wherein:
said projected light is for selective highlighting one at least said storage locations.

112. The system for storing plural bottles of wine of claim 96 wherein said storage locations are for use as one at least of:
a) a wine rack,
b) a wine cellar,
c) the presentation of bottles of wine for sale;
wherein;
said storage locations includes an opening for:
placing a bottle of wine to the location, and
removing a stored bottle of wine from the location; and
said storage location provides for the display of part at least of a bottle at the storage location.

113. The system for storing plural bottles of wine of claim 112 wherein the storage locations are arranged for storing the bottles essentially horizontally with respect to the bottle's long axis, said essentially horizontal meaning closer to the horizontal than vertical, and
said opening is at the front, and
the long axis of the storage location extends from the front towards the back.

114. The system for storing plural bottles of wine of claim 113 wherein movement of part at least of the ID reader comprises one at least of:
a) vertically across the back of the storage locations,
b) horizontally across the back of the storage locations,
c) from the back of a storage location into the storage location.

115. The system for storing plural bottles of wine further comprising a track for part at least of the ID reader wherein said track passes through or proximal to a plurality of said storage locations.

116. The system for storing plural bottles of wine of claim 96 further comprising the computer controlled selective indication by light of one of the storage locations from at least one other storage location in response to the input of information related to a bottle of wine for storage at the location or stored at the location.

117. The system for storing plural bottles of wine of claim 107 wherein said input information comprises one at least of:
a) vintage,
b) type,
c) producer,
of the wine in the first bottle.

118. The system for storing plural bottles of wine of claim 116 wherein said light comprises the use of projected light.

119. The system for storing plural bottles of wine of claim 118 wherein the path of said projected light is determined in part at least by the computer controlled electro-mechanical movement of one at least of a:
a) light source,
b) reflector,
c) prism,
d) lense.

120. The system for storing plural bottles of wine of claim 117 wherein said light is from one at least members of a strip of separately illuminable members in one at least of:
a) an approximately at least vertically extending void,
b) an approximately at horizontally extending void,
in said structure and or supporting members of the structure; and
said illuminable members comprise a first member associable with the first storage location and a second member associable with the second storage location.

121. The system for storing plural bottles of wine of claim 120 wherein said strip comprises one at least of the following functions:
a) insertable into the void after formation of said void,
b) removable from said void.
